(19) United States
(12) Patent Application Publication
(10) Pub. No.: US 2011/0205259 A1
(43) Pub. Date: Aug. 25, 2011

(54) SYSTEM AND METHOD FOR SELECTING DISPLAY MODES

(75) Inventor: Nesbitt W. Hagood, IV, Wellesley, MA (US)

(73) Assignee: Pixtronix, Inc., Andover, MA (US)

(21) Appl. No.: 13/126,104

(22) PCT Filed: Oct. 28, 2009
(86) PCT No.: PCT/US09/62365

§ 371 Date: Apr. 26, 2011

Related U.S. Application Data
(60) Provisional application No. 61/109,043, filed on Oct. 28, 2008.

(51) Int. Cl. G09G 5/10

(52) U.S. Cl. 345/690

(57) ABSTRACT

A field sequential display includes at least two lamps which output different colors and a controller. The controller is configured for receiving information from a host device in which the field sequential display is incorporated, selecting, based on the received information, a display mode from a plurality of preset display modes, and outputting signals indicating brightness levels with which to illuminate the at least two lamps based on the selected display mode.

### REFERENCE TO RELATED APPLICATIONS

This application claims the benefit of U.S. Provisional Patent Application Ser. No. 61/109,043, filed on Oct. 28, 2008, which is incorporated by reference herein in its entirety.

### BACKGROUND OF THE INVENTION

As portable devices progressively include more features and become more complex, battery power increasingly becomes a limiting factor in the performance of such devices. Conventional displays for portable devices use a substantial amount of battery power, and provide little control over power usage. Many portable devices now provide the ability to display a wide range of content, from text to photographs or videos. Additionally, current portable devices have the ability to perform various functions, such as phone calls, internet browsing, or tuning television signals. Displays of portable devices generally have one method of displaying the wide range of content and various functions provided by the device, thus consuming a high level of battery power for all types of content or functions. A need exists for portable device displays that provide for flexibility in the method of displaying content in order to control power consumption.

### SUMMARY OF THE INVENTION

According to one aspect the invention relates to a field sequential display that includes at least two lamps that output different colors and a controller. The controller is configured for receiving information from a host device in which the field sequential display is incorporated. In one embodiment, the information received from the host device includes raw image data. In one embodiment the information received from the host device includes an identifier of a type of image to be displayed. In another embodiment, the information received from the host device includes an identifier of the display mode. In another embodiment, the information received from the host device includes an identifier of a user mode selected by the user of the host device. In yet another embodiment, the information received from the host device includes an identifier of a type of content to be displayed. In further embodiment, the information received from the host device includes an identifier of a device operating mode. In one particular embodiment, the information received from the host device includes at least two of raw image data, an identifier of a type of image to be displayed, an identifier of the display mode, an identifier of a user mode selected by the user of the host device, an identifier of a type of content to be displayed, and an identifier of a device operating mode. In various embodiments, the processor is configured to receive the information from the host device according to a predetermined codec.

The controller is also configured for selecting, based on the received information, a display mode from a plurality of preset display modes. In one embodiment, the controller is configured to select the display mode that consumes less power in comparison to at least one other display mode of the plurality of preset display modes. In another embodiment, selecting a display mode includes selecting a combination of the plurality of display modes In various embodiments, each of the plurality of preset display modes has an associated plurality of imaging characteristics and each of the plurality of preset display modes includes a unique combination of imaging characteristic values. In one embodiment, the plurality of imaging characteristics includes at least a color gamut. In one embodiment, the plurality of imaging characteristics includes at least a number of bit levels used in the display mode to display colors. In another embodiment, the plurality of imaging characteristics includes at least a level of gamma correction. In one embodiment, the plurality of imaging characteristics includes at least a frame rate. In a further embodiment, the plurality of imaging characteristics includes at least a resolution characteristic. In yet another embodiment, the plurality of imaging characteristics includes at least a brightness level.

The controller is also configured for outputting signals indicating brightness levels with which to illuminate the at least two lamps based on the selected display mode. In one embodiment, the field sequential display includes an array of light modulators and the processor is configured to regulate drive signals applied to the array at times determined based on the selected display mode. In various embodiments the field sequential display includes a memory for storing the plurality of preset image modes.

According to another aspect, the invention relates to a field sequential display that includes at least two lamps which output different colors and a controller. The controller is configured for receiving information from a host device in which the field sequential display is incorporated, and for selecting, based on the received information, a display mode from a plurality of preset display modes. The controller is further configured for determining a number of bitplanes to use in relation to each color associated with each of the at least two lamps based on the selected display mode, receiving image data corresponding to an image frame, and generating the determined number of bitplanes based on the image data.

According to another aspect, the invention relates to a field sequential display that includes at least two lamps which output different colors and a controller. The controller is configured for receiving information from a host device in which the field sequential display is incorporated, and for selecting, based on the received information, a display mode from a plurality of preset display modes. The controller is further configured for determining a gamma parameter for use in displaying at least one image frame base on the selected display mode, receiving image data corresponding to an image frame, and outputting control signals based on the image data and determined gamma parameter.

### BRIEF DESCRIPTION

In the detailed description which follows, reference will be made to the attached drawings, in which:

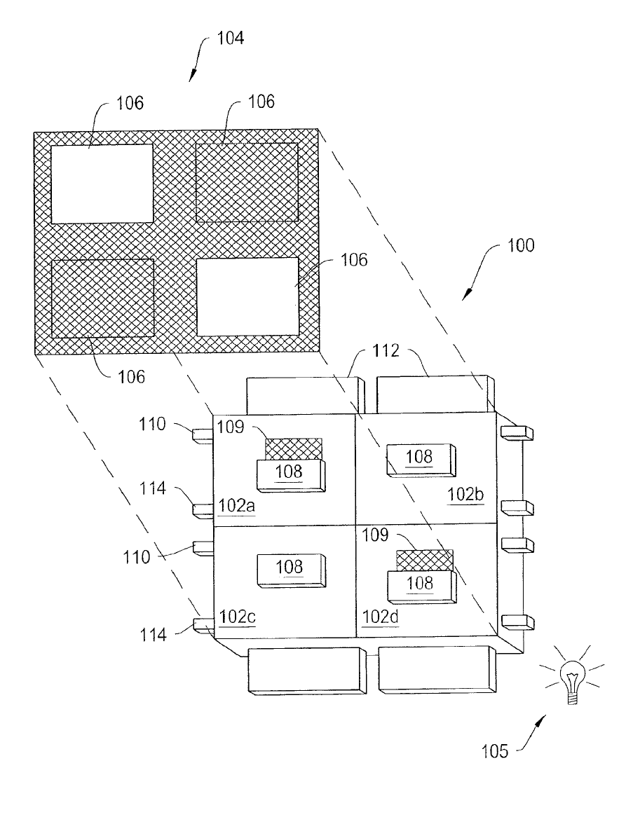

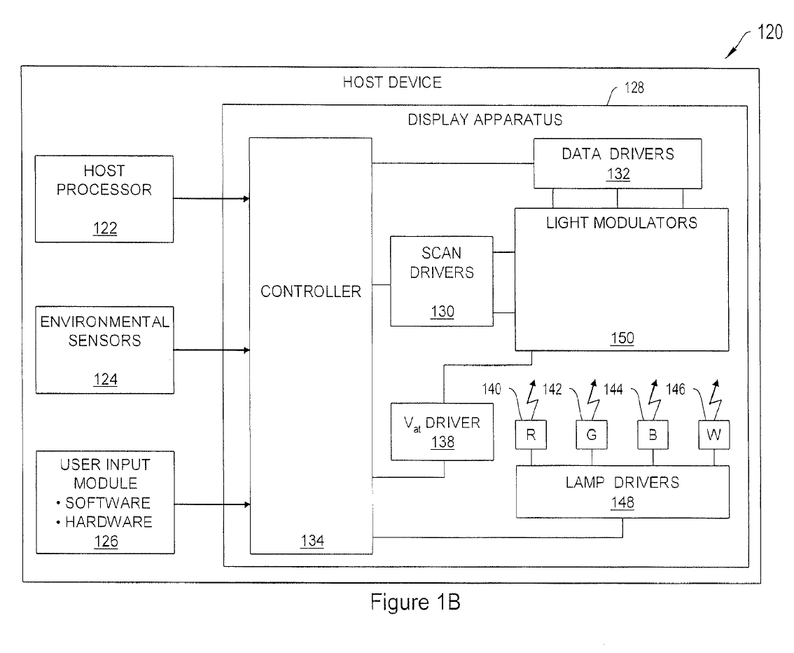

FIG. 1A is a schematic diagram of a direct-view MEMS-based display apparatus, according to an illustrative embodiment of the invention;

FIG. 1B is a block diagram of a host device according to an illustrative embodiment of the invention;

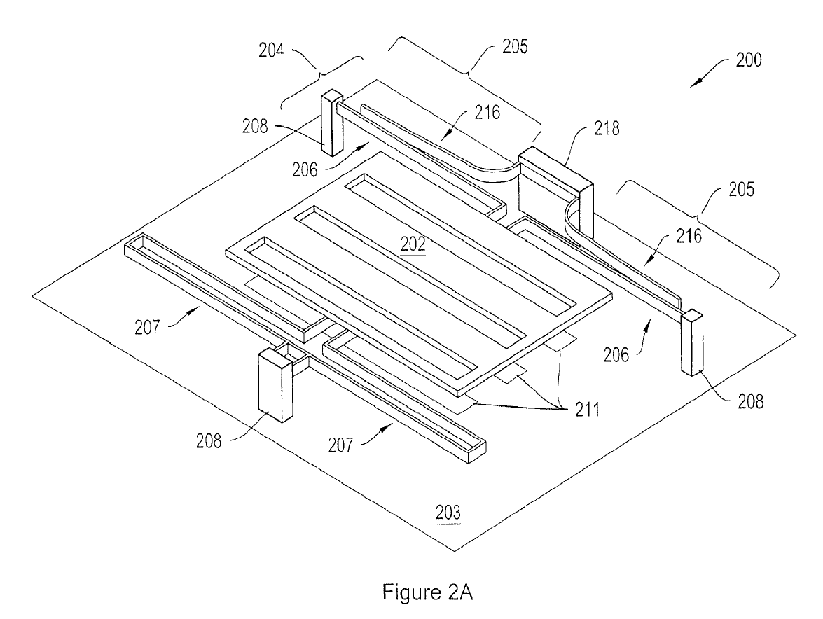

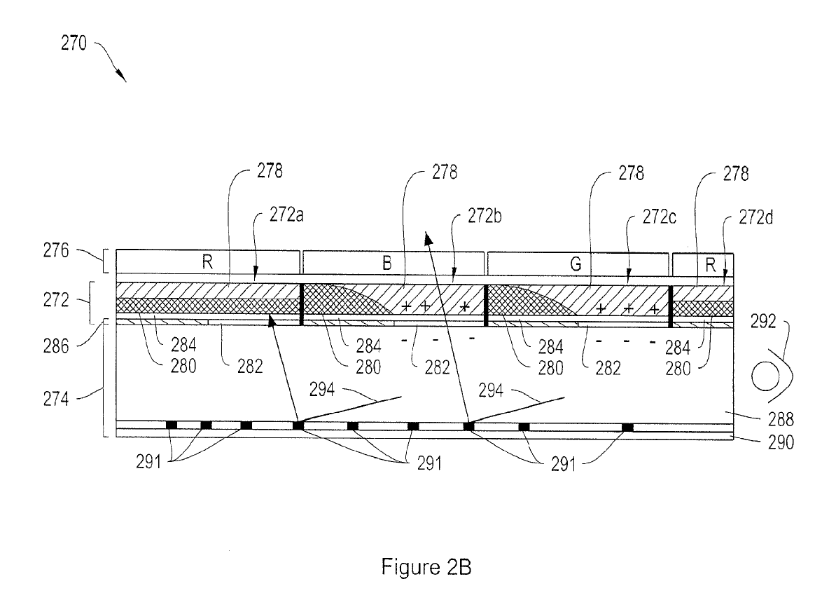

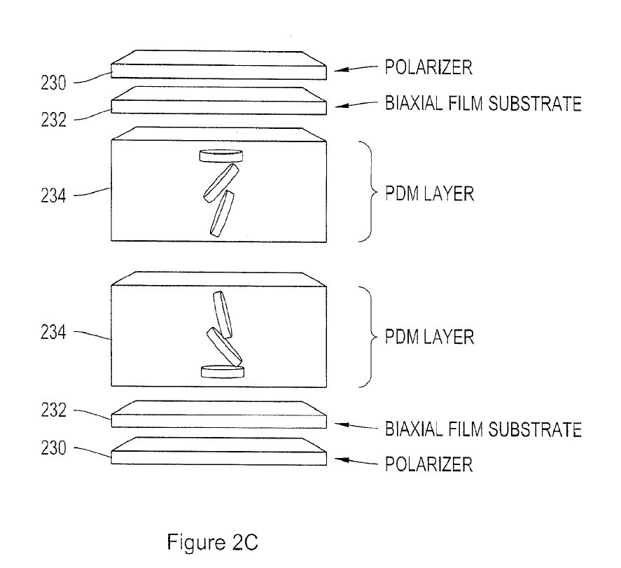

FIG. 2A is a perspective view of an illustrative shutter-based light modulator suitable for incorporation into the direct-view MEMS-based display apparatus of FIG. 1A, according to an illustrative embodiment of the invention;

FIG. 2B is a cross sectional view of an illustrative non-shutter-based light modulator suitable for inclusion in various embodiments of the invention;

FIG. 2C is an example of a field sequential liquid crystal display operating in optically compensated bend (OCB) mode.

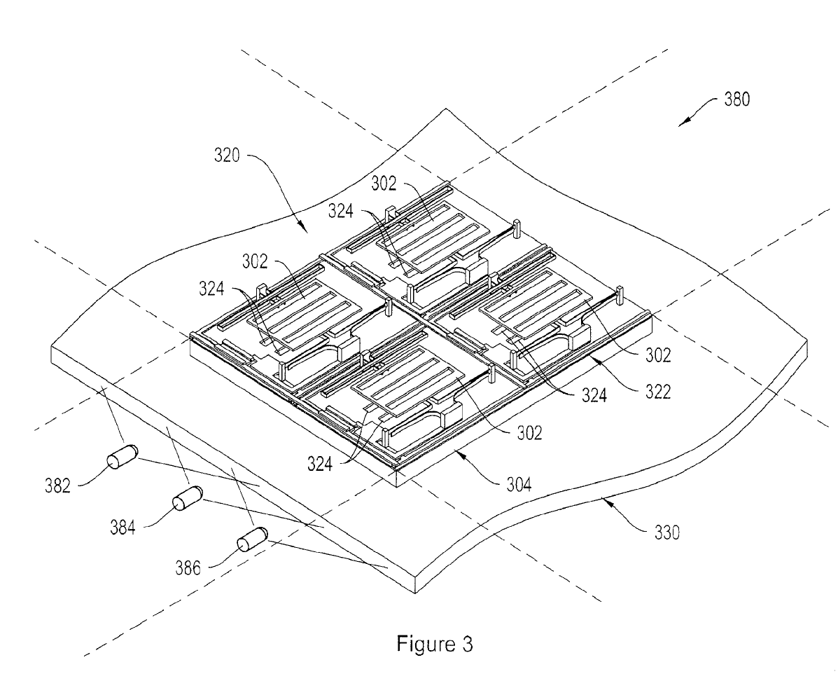

FIG. 3 is a perspective view of an array of shutter-based light modulators, according to an illustrative embodiment of the invention;

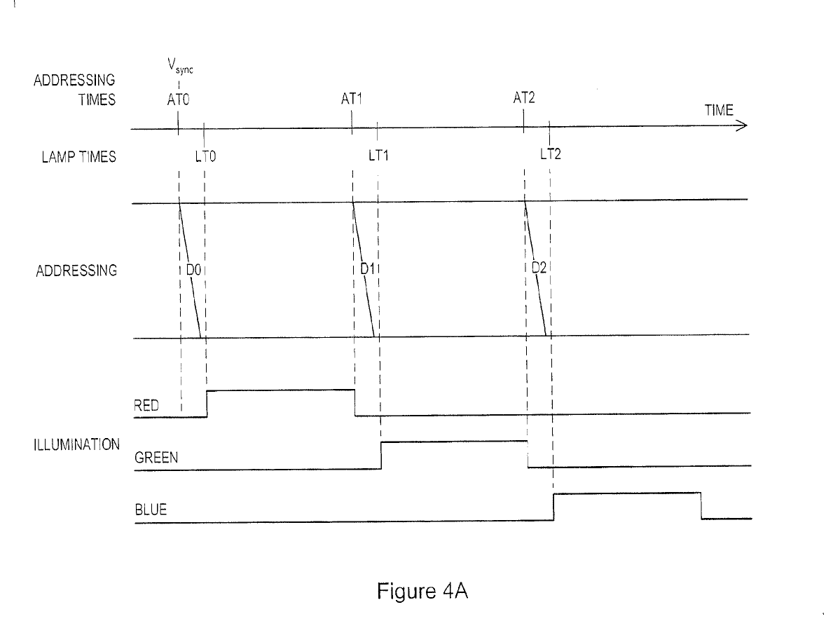

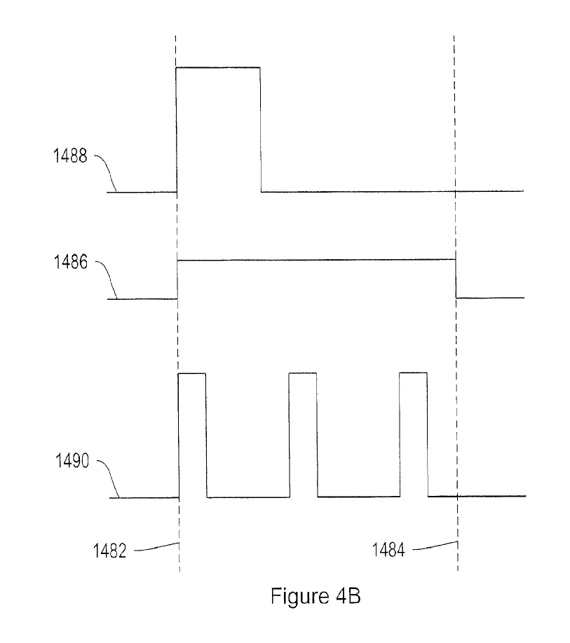

FIG. 4A is a timing diagram corresponding to a display process for displaying images using field sequential color according to an illustrative embodiment of the invention;

FIG. 4B is a diagram showing alternate pulse profiles for lamps appropriate to this invention;

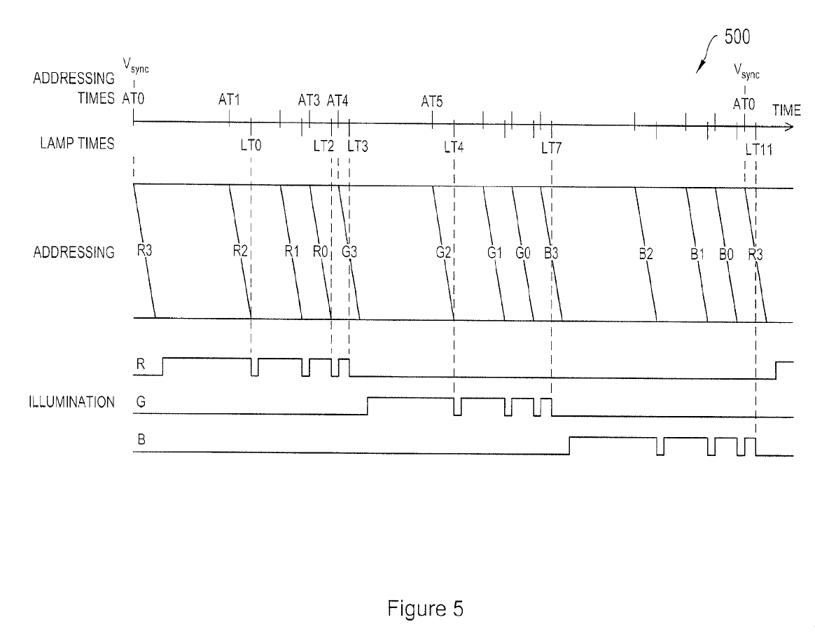

FIG. 5 is a timing sequence employed by the controller for the formation of an image using a series of sub-frame images in a binary time division gray scale according to an illustrative embodiment of the invention;

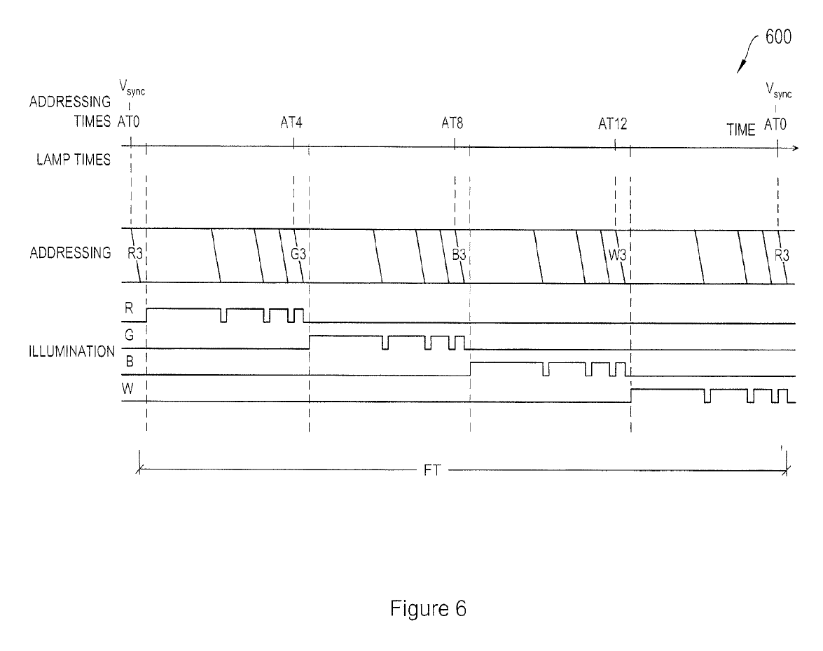

FIG. 6 is a timing diagram that corresponds to a coded-time division grayscale addressing process in which image frames are displayed by displaying four sub-frame images for each color component of the image frame according to an illustrative embodiment of the invention;

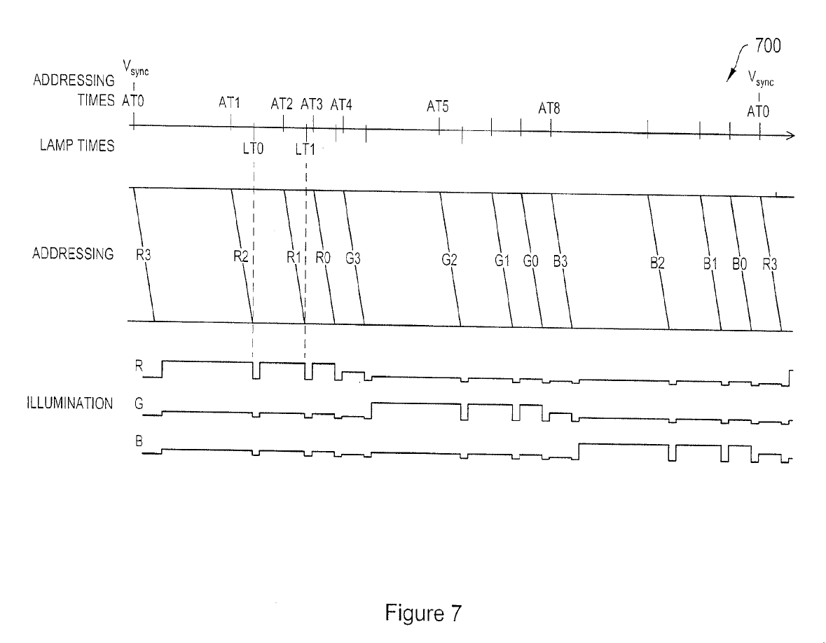

FIG. 7 is a timing diagram that corresponds to a hybrid coded-time division and intensity grayscale display process in which lamps of different colors may be illuminated simultaneously according to an illustrative embodiment of the invention;

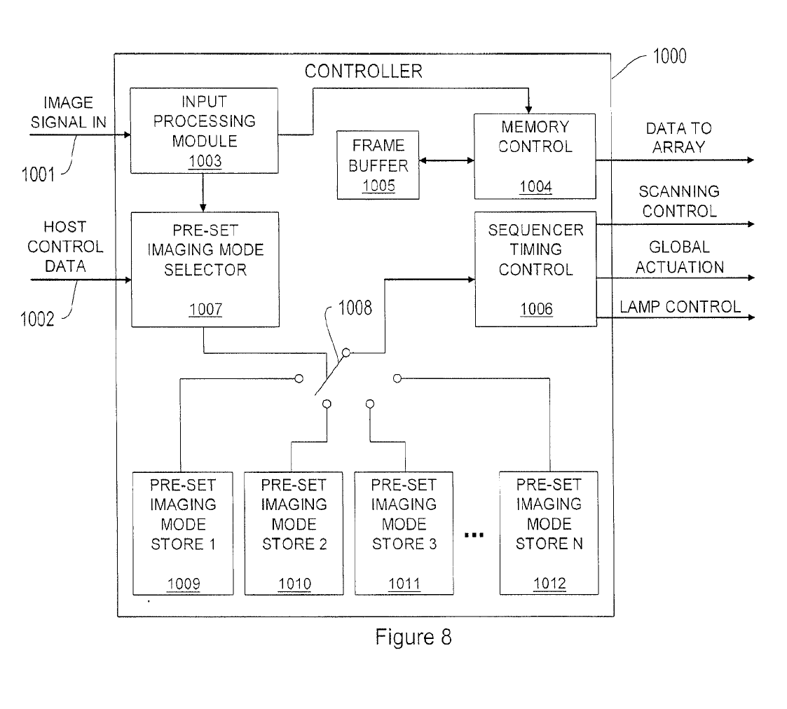

FIG. 8 is a block diagram of a controller for use in a direct-view display, according to an illustrative embodiment of the invention;

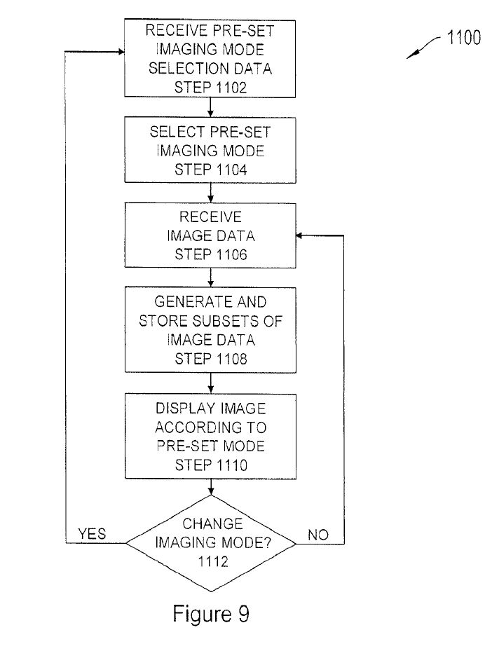

FIG. 9 is a flow chart of a process of displaying images suitable for use by a direct-view display according to an illustrative embodiment of the invention;

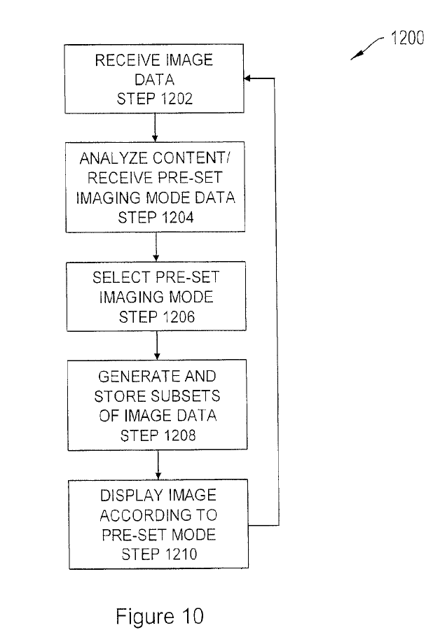

FIG. 10 depicts a display method by which the controller can adapt the display characteristics based on the content of incoming image data;

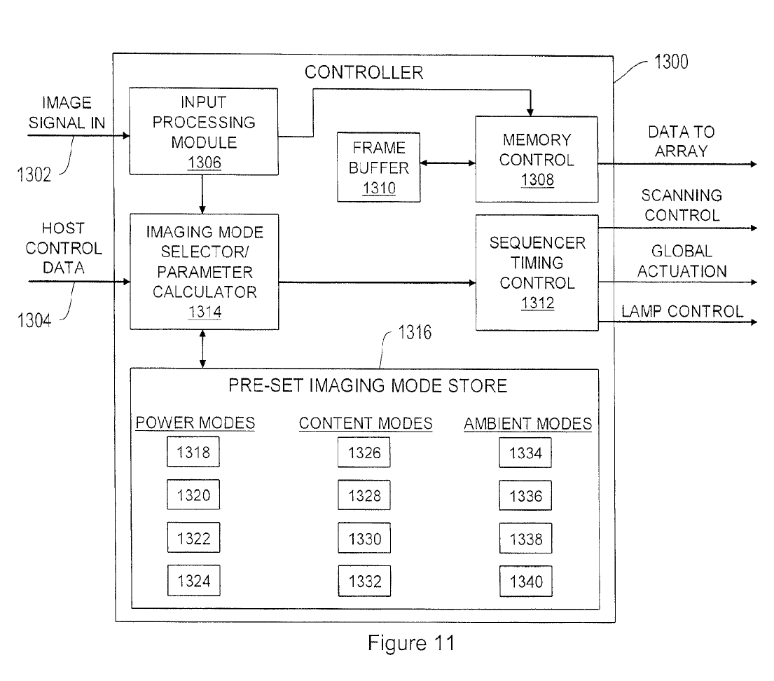

FIG. 11 is a block diagram of a controller for use in a direct-view display, according to an illustrative embodiment of the invention;

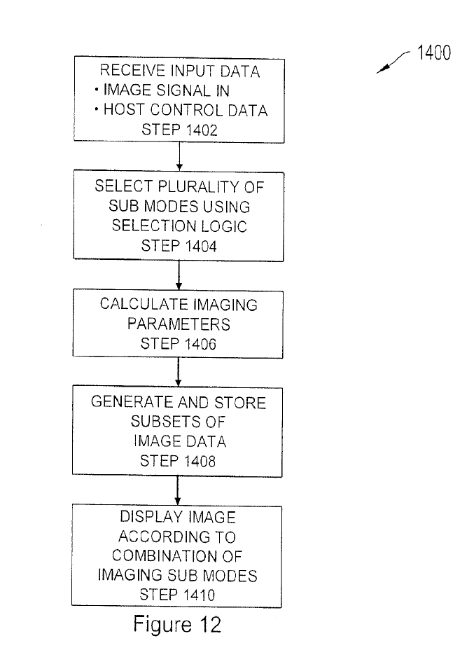

FIG. 12 is a flow chart of a process of displaying images suitable for use by a direct-view display controller according to an illustrative embodiment of the invention;

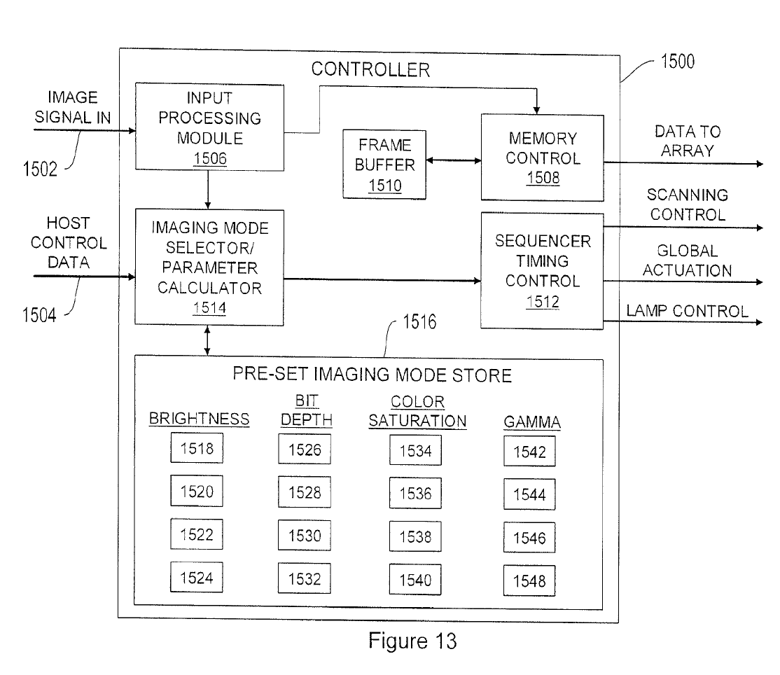

FIG. 13 is a block diagram of a controller for use in a direct-view display, according to an illustrative embodiment of the invention;

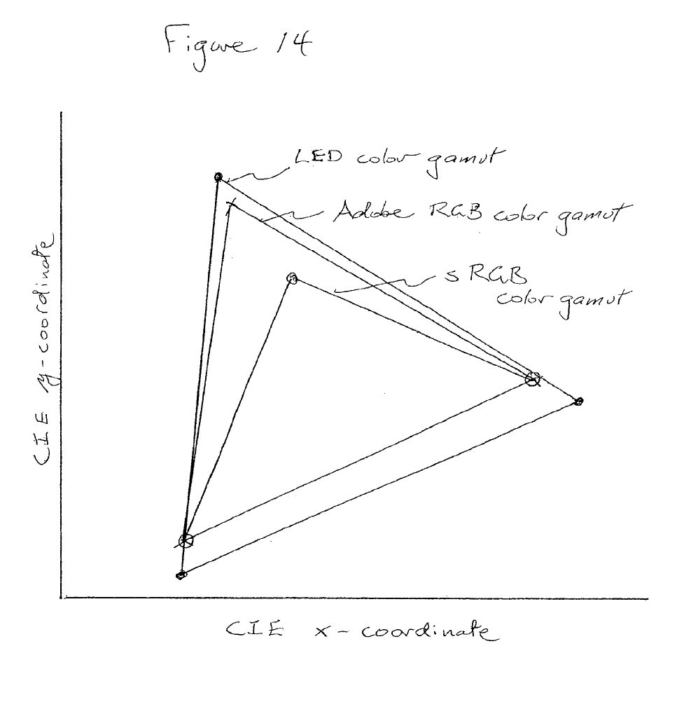

FIG. 14 is an x-y chromaticity diagram illustrating a variety of color gamuts achievable using LEDs in the display according to an illustrative embodiment of the invention. Amongst the achievable color gamuts are the Adobe RGB color space and the sRGB color space;

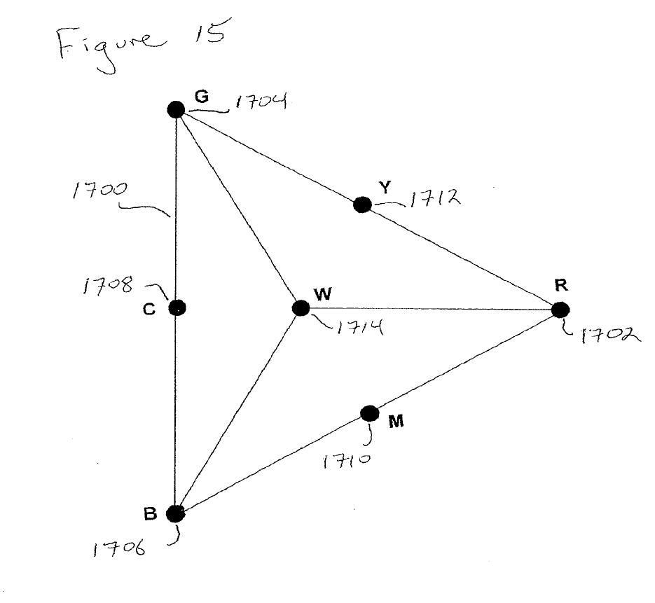

FIG. 15 is an x-y chromaticity diagram illustrating several colors achievable using LEDs in the display according to an illustrative embodiment of the invention;

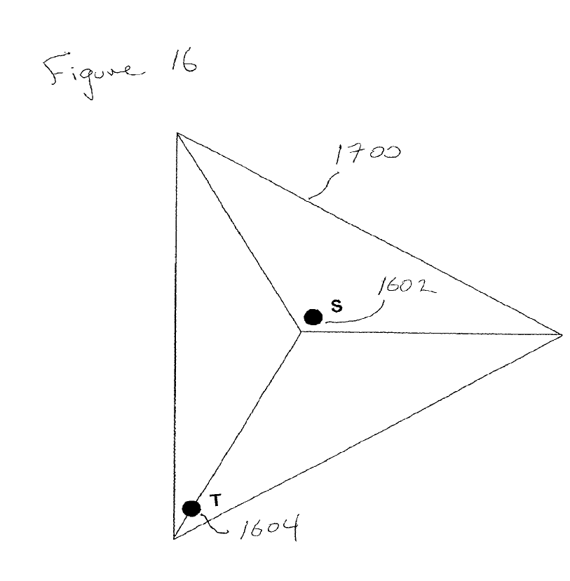

FIG. 16 is an x-y chromaticity diagram illustrating two additional colors achievable using LEDs in the display according to an illustrative embodiment of this invention.

### DESCRIPTION OF CERTAIN ILLUSTRATIVE EMBODIMENTS

FIG. 1 is a schematic diagram of a direct-view MEMS-based display apparatus 100, according to an illustrative embodiment of the invention. The display apparatus 100 includes a plurality of light modulators 102a-102B (generally “light modulators 102”) arranged in rows and columns. In the display apparatus 100, light modulators 102a and 102B are in the open state, allowing light to pass. Light modulators 102b and 102c are in the closed state, obstructing the passage of light. By selectively setting the states of the light modulators 102a-102B, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e. by use of a front light.

In the display apparatus 100, each light modulator 102 corresponds to a pixel 106 in the image 104. In other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

Display apparatus 100 is a direct-view display in that it does not require imaging optics that are necessary for projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112, and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{we}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B is a block diagram 120 of a host device (i.e. cell phone, PDA, MP3 player, etc.). The host device includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, and lamp drivers 148. The scan drivers 130 apply write enabling voltages to scan-line interconnects 110. The data drivers 132 apply data voltages to the data interconnects 112.

In some embodiments of the display apparatus, the data drivers 132 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104. In other cases the data drivers 132 are configured to apply only a reduced set of 2, 3, or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display 100 apparatus optionally includes a set of common drivers 138, also referred to as common voltage sources. In some embodiments the common drivers 138 provide a DC common potential to all light modulators within the array of light modulators, for instance by supplying voltage to a series of common interconnects 114. In other embodiments the common drivers 138, following commands from the controller 134, issue voltage pulses or signals to the array of light modulators, for instance global actuation pulses which are capable of driving and/or initiating simultaneous actuation of all light modulators in multiple rows and columns of the array.

All of the drivers (e.g., scan drivers 130, data drivers 132, and common drivers 138) for different display functions are time-synchronized by the controller 134. Timing commands from the controller coordinate the illumination of red, green and blue and white lamps (140, 142, 144, and 146 respectively) via lamp drivers 148, the write-enabling and sequencing of specific rows within the array of pixels, the output of voltages from the data drivers 132, and the output of voltages that provide for light modulator actuation.

The controller 134 determines the sequencing or addressing scheme by which each of the shutters 108 can be re-set to the illumination levels appropriate to a new image 104. Details of suitable addressing, image formation, and gray scale techniques can be found in U.S. Patent Application Publication Nos. US 200760250325 A1 and US 20015005969 A1 incorporated herein by reference. New images 104 can be set at periodic intervals. For instance, for video displays, the color images 104 or frames of video are refreshed at frequencies ranging from 10 to 300 Hertz. In some embodiments the setting of an image frame to the array is synchronized with the illumination of the lamps 140, 142, 144, and 146 such that alternate image frames are illuminated with an alternating series of colors, such as red, green, and blue. The image frames for each respective color is referred to as a color sub-frame. In this method, referred to as the field sequential color method, if the color sub-frames are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In other implementations the display apparatus 100 can provide gray scale through the use of multiple shutters 108 per pixel.

In some implementations the data for an image state 104 is loaded by the controller 134 to the modulator array by a sequential addressing of individual rows, also referred to as scan lines. For each row or scan line in the sequence, the scan driver 130 applies a write-enable voltage to the write enable interconnect 110 for that row of the array, and subsequently the data driver 132 supplies data voltages, corresponding to desired shutter states, for each column in the selected row. This process repeats until data has been loaded for all rows in the array. In some implementations the sequence of selected rows for data loading is linear, proceeding from top to bottom in the array. In other implementations the sequence of selected rows is pseudo-randomized, in order to minimize visual artifacts. And in other implementations the sequencing is organized by blocks, where, for a block, the data for only a certain fraction of the image state 104 is loaded to the array, for instance by addressing only every 5^{th} row of the array in sequence.

In some implementations, the process for loading image data to the array is separated in time from the process of actuating the shutters 108. In these implementations, the modulator array may include data memory elements for each pixel in the array and the control matrix may include a global actuation interconnect for carrying trigger signals, from common driver 138, to initiate simultaneous actuation of shutters 108 according to data stored in the memory elements. Various addressing sequences, many of which are described in U.S. patent application Ser. No. 11/643,042, can be coordinated by means of the controller 134.

In alternative embodiments, the array of pixels and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The host processor 122 generally controls the operations of the host. For example, the host processor may be a general or special purpose processor for controlling a portable electronic device. With respect to the display apparatus 128, included within the host device 120, the host processor outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In one embodiment, the user input module is controlled by software in which the user programs personal preferences such as “deeper color”, “better contrast”, “lower power”, “increased brightness”, “sports”, “live action”, or “animation”. In another embodiment, these preferences are input to the host using hardware, such as a switch or dial. The plurality of data inputs to the controller 134 direct the controller to provide data to the various drivers 130, 132, 138, and 148 which correspond to optimal imaging characteristics.

An environmental sensor module 124 is also included as part of the host device. The environmental sensor module receives data about the ambient environment, such as temperature and or ambient lighting conditions. The sensor module 124 can be programmed to distinguish whether the device is operating in an indoor or office environment versus an outdoor environment in bright daylight versus and outdoor environment at nighttime. The sensor module communicates this information to the display controller 134, so that the controller can optimize the viewing conditions in response to the ambient environment.

FIG. 2A is a perspective view of an illustrative shutter-based light modulator 200 suitable for incorporation into the direct-view MEMS-based display apparatus 100 of FIG. 1A, according to an illustrative embodiment of the invention. The light modulator 200 includes a shutter 202 coupled to an actuator 204. The actuator 204 is formed from two separate compliant electrode beam actuators 205 (the “actuators 205”), as described in U.S. Pat. No. 7,271,945 filed on Oct. 14, 2005. The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the first step of the processing sequence involves depositing a light blocking layer onto the substrate and etching the light blocking layer into an array of holes 211. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as light modulator 200, incorporates a passive restoring force, such as a spring, for returning a shutter to its rest position after voltages have been removed. Other shutter assemblies, as described in U.S. Pat. No. 7,271,945 and patent application publication No. US2006-0250325 A1, incorporate a dual set of “open” and “closed” actuators and a separate sets of “open” and “closed” electrodes for moving the shutter into either an open or a closed state.

U.S. Pat. No. 7,271,945 and application publication No. US2006-0250325 A1 have described a variety of methods by which an array of shutters and apertures can be controlled via a control matrix to produce images, in many cases moving images, with appropriate gray scale. In some cases control is accomplished by means of a passive matrix array of row and column interconnects connected to driver circuits on the periphery of the display. In other cases it is appropriate to include switching and/or data storage elements within each pixel of the array (the so-called active matrix) to improve either the speed, the gray scale and/or the power dissipation performance of the display.

The control matrices described herein are not limited to controlling shutter-based MEMS light modulators, such as the light modulators described above. FIG. 2B is a cross sectional view of an illustrative non-shutter-based light modulator suitable for inclusion in various embodiments of the invention. Specifically, FIG. 2B is a cross sectional view of an electrowetting-based light modulation array 270. The light modulation array 270 includes a plurality of electrowetting-based light modulation cells 272a-272B (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from indium-tin oxide) and an insulating layer 284 positioned between the layer of light absorbing oil 280 and the transparent electrode 282. Illustrative implementation of such cells are described further in U.S. Patent Application Publication No. 2005/0104804, published May 19, 2005 and entitled “Display Device.” In the embodiment described herein, the electrode takes up a portion of a rear surface of a cell 272.

The remainder of the rear surface of a cell 272 is formed from a reflective aperture layer 286 that forms the front surface of the optical cavity 274. The reflective aperture layer 286 is formed from a reflective material, such as a reflective metal or a stack of thin films forming a dielectric mirror. For each cell 272, an aperture is formed in the reflective aperture layer 286 to allow light to pass through. The electrode 282 for the cell is deposited in the aperture and over the material forming the reflective aperture layer 286, separated by another dielectric layer.

The remainder of the optical cavity 274 includes a light guide 288 positioned proximate the reflective aperture layer 286, and a second reflective layer 290 on a side of the light guide 288 opposite the reflective aperture layer 286. A series of light redirectors 291 are formed on the rear surface of the light guide, proximate the second reflective layer. The light redirectors 291 may be either diffuse or specular reflectors. One of more light sources 292 inject light 294 into the light guide 288.

In an alternative implementation, an additional transparent substrate is positioned between the light guide 290 and the light modulation array 270. In this implementation, the reflective aperture layer 286 is formed on the additional transparent substrate instead of on the surface of the light guide 290.

In operation, application of a voltage to the electrode 282 of a cell (for example, cell 272b or 272c) causes the light absorbing oil 280 in the cell to collect in one portion of the cell 272. As a result, the light absorbing oil 280 no longer obstructs the passage of light through the aperture formed in the reflective aperture layer 286 (see, for example, cells 272b and 272c). Light escaping the backlight at the aperture is then able to escape through the cell and through a corresponding color (for example, red, green, or blue) filter in the set of color filters 276 to form a color pixel in an image. When the electrode 282 is grounded, the light absorbing oil 280 covers the aperture in the reflective aperture layer 286, absorbing any light 294 attempting to pass through it.

The area under which oil 280 collects when a voltage is applied to the cell 272 constitutes wasted space in relation to forming an image. This area cannot pass light through, whether a voltage is applied or not, and therefore, without the inclusion of the reflective portions of reflective apertures layer 286, would absorb light that otherwise could be used to contribute to the formation of an image. However, with the inclusion of the reflective aperture layer 286, this light, which otherwise would have been absorbed, is reflected back into the light guide 290 for future escape through a different aperture. The electrowetting-based light modulation array 270 is not the only example of a non-shutter-based MEMS modulator suitable for control by the control matrices described herein. Other forms of non-shutter-based MEMS modulators could likewise be controlled by various ones of the control matrices described herein without departing from the scope of the invention.

In addition to MEMS displays, the invention may also make use of field sequential liquid crystal displays, including for example, liquid crystal displays operating in optically compensated bend (OCB) mode as shown in FIG. 2C. Coupling an OCB mode LCD display with the field sequential color method allows for low power and high resolution displays. The LCD of FIG. 2C is composed of a circular polarizer 230, a biaxial retardation film 232, and a polymerized discotic material (PDM) 234. The biaxial retardation film 232 contains transparent surface electrodes with biaxial transmission properties. These surface electrodes act to align the liquid crystal molecules of the PDM layer in a particular direction when a voltage is applied across them. The use of field sequential LCD's are described in more detail in T. Ishinabe et. al., “High Performance OCB-mode for Field Sequential Color LCDs”, Society for Information Display Digest of Technical Papers, 987 (2007), which is incorporated herein by reference.

FIG. 3 is a perspective view of an array 320 of shutter-based light modulators, according to an illustrative embodiment of the invention. FIG. 3 also illustrates the array of light modulators 320 disposed on top of backlight 330. In one implementation, the backlight 330 is made of a transparent material, i.e. glass or plastic, and functions as a light guide for evenly distributing light from lamps 382, 384, and 386 throughout the display plane. When assembling the display 380 as a field sequential display, the lamps 382, 384, and 386 can be alternate color lamps, e.g. red, green, and blue lamps respectively.

A number of different types of lamps 382-386 can be employed in the displays, including without limitation: incandescent lamps, fluorescent lamps, lasers, or light emitting diodes (LEDs). Further, lamp 382-386 of direct view display 380 can be combined into a single assembly containing multiple lamps. For instance a combination of red, green, and blue LEDs can be combined with or substituted for a white LED in a small semiconductor chip, or assembled into a small multi-lamp package. Similarly each lamp can represent an assembly of 4-color LEDs, for instance a combination of red, yellow, green, and blue LEDs.

The shutter assemblies 302 function as light modulators. By use of electrical signals from the associated control matrix the shutter assemblies 302 can be set into either an open or a closed state. Only the open shutters allow light from the lightguide 330 to pass through to the viewer, thereby forming a direct view image.

In direct view display 380 the light modulators are formed on the surface of substrate 304 that faces away from the light guide 330 and toward the viewer. In other implementations the substrate 304 can be reversed, such that the light modulators are formed on a surface that faces toward the light guide. In these implementations it is sometimes preferable to form an aperture layer, such as aperture layer 322, directly onto the top surface of the light guide 330. In other implementations it is useful to interpose a separate piece of glass or plastic between the light guide and the light modulators, such separate piece of glass or plastic containing an aperture layer, such as aperture layer 322, and associated aperture holes, such as aperture holes 324. It is preferable that the spacing between the plane of the shutter assemblies 302 and the aperture layer 322 be kept as close as possible, preferably less than 10 microns, in some cases as close as 1 micron.

Descriptions of other optical assemblies useful for this invention can be found in US Patent Application Publication No. 20060187528A1 filed Sep. 2, 2005 and entitled “Methods and Apparatus for Spatial Light Modulation” and in U.S. Patent Application Publication No. US 2007-0279727 A1 published Dec. 6, 2007 and entitled “Display Apparatus with Improved Optical Cavities,” which are both incorporated herein by reference.

In some displays, color pixels are generated by illuminating groups of light modulators corresponding to different colors, for example, red green and blue. Each light modulator in the group has a corresponding filter to achieve the desired color. The filters, however, absorb a great deal of light, in some cases as much as 60% of the light passing through the filters, thereby limiting the efficiency and brightness of the display. In addition, the use of multiple light modulators per pixel decreases the amount of space on the display that can be used to contribute to a displayed image, further limiting the brightness and efficiency of such a display.

The human brain, in response to viewing rapidly changing images, for example, at frequencies of greater than 20 Hz, averages images together to perceive an image which is the combination of the images displayed within a corresponding period. This phenomenon can be utilized to display color images while using only single light modulators for each pixel of a display, using a technique referred to in the art as field sequential color. The use of field sequential color techniques in displays eliminates the need for color filters and multiple light modulators per pixel. In a field sequential color enabled display, an image frame to be displayed is divided into a number of sub-frame images, each corresponding to a particular color component (for example, red, green, or blue) of the original image frame. For each sub-frame image, the light modulators of a display are set into states corresponding to the color component's contribution to the image. The light modulators then are illuminated by a lamp of the corresponding color. The sub-images are displayed in sequence at a frequency (for example, greater than 60 Hz) sufficient for the brain to perceive the series of sub-frame images as a single image. The data used to generate the sub-frames arc often fractured in various memory components. For example, in some displays, data for a given row of display are kept in a shift-register dedicated to that row. Image data is shifted in and out of each shift register to a light modulator in a corresponding column in that row of the display according to a fixed clock cycle. Other implementations of circuits for controlling displays are described in U.S. Patent Publication No. US 2007-0086078 A1 published Apr. 19, 2007 and entitled “Circuits for Controlling Display Apparatus,” which is incorporated herein by reference.

FIG. 4A is a timing diagram 400 corresponding to a display process for displaying images using field sequential color, which can be implemented according to an illustrative embodiment of the invention, for example, by a MEMS direct-view display described in FIG. 1b. The timing diagrams included herein, including the timing diagram 400 of FIGS. 4A, 5, 6 and 7 conform to the following conventions. The top portions of the timing diagrams illustrate light modulator addressing events. The bottom portions illustrate lamp illumination events.

The addressing portions depict addressing events by diagonal lines spaced apart in time. Each diagonal line corresponds to a series of individual data loading events during which data is loaded into each row of an array of light modulators, one row at a time. Depending on the control matrix used to address and drive the modulators included in the display, each loading event may require a waiting period to allow the light modulators in a given row to actuate. In some implementations, all rows in the array of light modulators are addressed prior to actuation of any of the light modulators. Upon completion of loading data into the last row of the array of light modulators, all light modulators are actuated substantially simultaneously.

Lamp illumination events are illustrated by pulse trains corresponding to each color of lamp included in the display. Each pulse indicates that the lamp of the corresponding color is illuminated, thereby displaying the sub-frame image loaded into the array of light modulators in the immediately preceding addressing event.

The time at which the first addressing event in the display of a given image frame begins is labeled on each timing diagram as AT0. In most of the timing diagrams, this time falls shortly after the detection of a voltage pulse vsync, which precedes the beginning of each video frame received by a display. The times at which each subsequent addressing event takes place are labeled as AT1, AT2, . . . AT(n-1), where n is the number of sub-frame images used to display the image frame. In some of the timing diagrams, the diagonal lines are further labeled to indicate the data being loaded into the array of light modulators. For example, in the timing diagram of FIG. 4, D0 represents the first data loaded into the array of light modulators for a frame and D(n-1) represents the last data loaded into the array of light modulators for the frame. In the timing diagrams of FIGS. 5-7, the data loaded during each addressing event corresponds to a bitplane.

A bitplane is a coherent set of data identifying desired modulator states for modulators in multiple rows and multiple columns of an array of light modulators. Moreover, each bitplane corresponds to one of a series of sub-frame images derived according to a binary coding scheme. That is, each sub-frame image for a color component of an image frame is weighted according to a binary series 1, 2, 4, 8, 16, etc. The bitplane with the lowest weighting is referred to as the least significant bitplane and is labeled in the timing diagrams and referred to herein by the first letter of the corresponding color component followed by the number 0. For each next-most significant bitplane for the color components, the number following the first letter of the color component increases by one. For example, for an image frame broken into 4 bitplanes per color, the least significant red bitplane is labeled and referred to as the R0 bitplane. The next most significant red bitplane is labeled and referred to as R1, and the most significant red bitplane is labeled and referred to as R3.

Lamp-related events are labeled as LT0, LT1, LT2 . . . LT(n-1). The lamp-related event times labeled in a timing diagram, depending on the timing diagram, either represent times at which a lamp is illuminated or times at which a lamp is extinguished. The meaning of the lamp times in a particular timing diagram can be determined by comparing their position in time relative to the pulse trains in the illumination portion of the particular timing diagram. Specifically referring back to the timing diagram 400 of FIG. 4A, to display an image frame according to the timing diagram 400, a single sub-frame image is used to display each of three color components of an image frame. First, data, D0, indicating modulator states desired for a red sub-frame image are loaded into an array of light modulators beginning at time AT0. After addressing is complete, the red lamp is illuminated at time LT0, thereby displaying the red sub-frame image. Data, D1, indicating modulator states corresponding to a green sub-frame image are loaded into the array of light modulators at time AT1. A green lamp is illuminated at time LT1. Finally, data, D2, indicating modulator states corresponding to a blue sub-frame image are loaded into the array of light modulators and a blue lamp is illuminated at times AT2 and LT2, respectively. The process then repeats for subsequent image frames to be displayed.

The level of gray scale achievable by a display that forms images according to the timing diagram of FIG. 4A depends on how finely the state of each light modulator can be controlled. For example, if the light modulators are binary in nature, i.e., they can only be on or off, the display will be limited to generating 8 different colors. The level of gray scale can be increased for such a display by providing light modulators than can be driven into additional intermediate states. In some embodiments related to the field sequential technique of FIG. 4A, MEMS light modulators can be provided which exhibit an analog response to applied voltage. The number of grayscale levels achievable in such a display is limited only by the resolution of digital to analog converters which are supplied in conjunction with data voltage sources.

Alternatively, finer grayscale can be generated if the time period used to display each sub-frame image is split into multiple time periods, each having its own corresponding sub-frame image. For example, with binary light modulators, a display that forms two sub-frame images of equal length and light intensity per color component can generate 27 different colors instead of 8. Gray scale techniques that break each color component of an image frame into multiple sub-frame images are referred to, generally, as time division gray scale techniques.

It is useful to define an illumination value as the product (or the integral) of an illumination period (or pulse width) with the intensity of that illumination. For a given time interval assigned in an output sequence for the illumination of a bitplane there are numerous alternative methods for controlling the lamps to achieve any required illumination value. Three such alternate pulse profiles for lamps appropriate to this invention are compared in FIG. 4B. In FIG. 4B the time markers 1482 and 1484 determine time limits within which a lamp pulse must express its illumination value. In a global actuation scheme for driving MEMS-based displays, the time marker 1482 might represent the end of one global actuation cycle, wherein the modulator states are set for a bitplane previously loaded, while the time marker 1484 can represent the beginning of a subsequent global actuation cycle, for setting the modulator states appropriate to the subsequent bitplane. For bitplanes with smaller significance, the time interval between the markers 1482 and 1484 can be constrained by the time necessary to load data subsets, e.g. bitplanes, into the array of modulators. The available time interval, in these cases, is substantially longer that the time required for illumination of the bitplane, assuming a simple scaling from the pulse widths assigned to bits of larger significance.

The lamp pulse 1486 is a pulse appropriate to the expression of a particular illumination value. The pulse width 1486 completely fills the time available between the markers 1482 and 1484. The intensity or amplitude of lamp pulse 1486 is adjusted, however, to achieve a required illumination value. An amplitude modulation scheme according to lamp pulse 1486 is useful, particularly in cases where lamp efficiencies are not linear and power efficiencies can be improved by reducing the peak intensities required of the lamps.

The lamp pulse 1488 is a pulse appropriate to the expression of the same illumination value as in lamp pulse 1486. The illumination value of pulse 1488 is expressed by means of pulse width modulation instead of by amplitude modulation. For many bitplanes the appropriate pulse width will be less than the time available as determined by the addressing of the bitplanes.

The series of lamp pulses 1490 represent another method of expressing the same illumination value as in lamp pulse 1486. A series of pulses can express an illumination value through control of both the pulse width and the frequency of the pulses. The illumination value can be considered as the product of the pulse amplitude, the available time period between markers 1482 and 1484, and the pulse duty cycle.

Lamp driver circuitry can be programmed to produce any of the above alternate lamp pulses 1486, 1488, or 1490. For example, the lamp driver circuitry can be programmed to accept a coded word for lamp intensity from the timing control module 724 and build a sequence of pulses appropriate to intensity. The intensity can be varied as a function of either pulse amplitude or pulse duty cycle.

FIG. 5 illustrates an example of a timing sequence, referred to as display process 500, employed by controller 134 for the formation of an image using a series of sub-frame images in a binary time division gray scale. The controller 134, used with display process 500, is responsible for coordinating multiple operations in the timed sequence (time varies from left to right in FIG. 5). The controller 134 determines when data elements of a sub-frame data set are transferred out of the frame buffer and into the data drivers 132. The controller 134 also sends trigger signals to enable the scanning of rows in the array by means of scan drivers 130, thereby enabling the loading of data from the data from drivers 132 into the pixels of the array. The controller 134 also governs the operation of the lamp drivers 148 to enable the illumination of the lamps 140, 142, 144 (the white lamp 146 is not employed in display process 500). The controller 134 also sends trigger signals to the common drivers 138 which enable functions such as the global actuation of shutters substantially simultaneously in multiple rows and columns of the array.

The process of forming an image in display process 500 comprises, for each sub-frame image, first the loading of a sub-frame data set out of the frame buffer and into the array. A sub-frame data set includes information about the desired states of modulators (e.g. open vs closed) in multiple rows and multiple columns of the array. For binary time division gray scale, a separate sub-frame data set is transmitted to the array for each bit level within each color in the binary coded word for gray scale. For the case of binary coding, a sub-frame data set is referred to as a bit plane. (Coded time division schemes using other than binary coding are described in U.S. Patent Application Publication No. US 20015005969 A1) The display process 500 refers to the loading of 4 bitplane data sets in each of the three colors red, green, and blue. These data sets are labeled as R0, R1, R2, and R4 for red, G0-G3 for green, and B0-B3 for blue. For economy of illustration only 4 bit levels per color are illustrated in the display process 500, although it will be understood that alternate image forming sequences are possible that employ 6,7, 8, or 10 bit levels per color.

The display process 500 refers to a series of addressing times AT0, AT1, AT2, etc. These times represent the beginning times or trigger times for the loading of particular bitplanes into the array. The first addressing time AT0 coincides with Vsync, which is a trigger signal commonly employed to denote the beginning of an image frame. The display process 500 also refers to a series of lamp illumination times LT0, LT1, LT2, etc., which are coordinated with the loading of the bitplanes. These lamp triggers indicate the times at which the illumination from one of the lamps 140, 142, 144 is extinguished. The illumination pulse periods and amplitudes for each of the red, green, and blue lamps are illustrated along the bottom of FIG. 5, and labeled along separate lines by the letters “R”, “G”, and “B”.

The loading of the first bitplane R3 commences at the trigger point AT0. The second bitplane to be loaded, R2, commences at the trigger point AT1. The loading of each bitplane requires a substantial amount of time. For instance the addressing sequence for bitplane R2 commences in this illustration at AT1 and ends at the point LT0. The addressing or data loading operation for each bitplane is illustrated as a diagonal line in timing diagram 500. The diagonal line represents a sequential operation in which individual rows of bitplane information are transferred out of the frame buffer, one at a time, into the data drivers 132 and from there into the array. The loading of data into each row or scan line requires anywhere from 1 microsecond to 100 microseconds. The complete transfer of multiple rows or the transfer of a complete bitplane of data into the array can take anywhere from 100 microseconds to 5 milliseconds, depending on the number of rows in the array.

In display process 500, the process for loading image data to the array is separated in time from the process of moving or actuating the shutters 108. For this implementation, the modulator array includes data memory elements, such as a storage capacitor, for each pixel in the array and the process of data loading involves only the storing of data (i.e. on-off or open-close instructions) in the memory elements. The shutters 108 do not move until a global actuation signal is generated by one of the common drivers 138. The global actuation signal is not sent by the controller 134 until all of the data has been loaded to the array. At the designated time, all of the shutters designated for motion or change of state are caused to move substantially simultaneously by the global actuation signal. A small gap in time is indicated between the end of a bitplane loading sequence and the illumination of a corresponding lamp. This is the time required for global actuation of the shutters. The global actuation time is illustrated, for example, between the trigger points LT2 and AT4. It is preferable that all lamps be extinguished during the global actuation period so as not to confuse the image with illumination of shutters that are only partially closed or open. The amount of time required for global actuation of shutters, such as in shutter assemblies 320, can take, depending on the design and construction of the shutters in the array, anywhere from 10 microseconds to 500 microseconds.

For the example of display process 500 the sequence controller is programmed to illuminate just one of the lamps after the loading of each bitplane, where such illumination is delayed after loading data of the last scan line in the array by an amount of time equal to the global actuation time. Note that loading of data corresponding to a subsequent bitplane can begin and proceed while the lamp remains on, since the loading of data into the memory elements of the array does not immediately affect the position of the shutters.

Each of the sub-frame images, e.g. those associated with bitplanes R3, R2, R1, and R0 is illuminated by a distinct illumination pulse from the red lamp 140, indicated in the “R” line at the bottom of FIG. 5. Similarly, each of the sub-frame images associated with bitplanes G3, G2, G1, and G0 is illuminated by a distinct illumination pulse from the green lamp 142, indicated by the “G” line at the bottom of FIG. 5. The illumination values (for this example the length of the illumination periods) used for each sub-frame image are related in magnitude by the binary series 8,4,2,1, respectively. This binary weighting of the illumination values enables the expression or display of a gray scale coded in binary words, where each bitplane contains the pixel on-off data corresponding to just one of the place values in the binary word. The commands that emanate from the sequence controller 160 ensure not only the coordination of the lamps with the loading of data but also the correct relative illumination period associated with each data bitplane.

A complete image frame is produced in display process 500 between the two subsequent trigger signals Vsync. A complete image frame in display process 500 includes the illumination of 4 bitplanes per color. For a 60 Hz frame rate the time between Vsync signals is 16.6 milliseconds. The time allocated for illumination of the most significant bitplanes (R3, G3, and B3) can be in this example approximately 2.4 milliseconds each. By proportion then, the illumination times for the next bitplanes R2, G2, and B2 would be 1.2 milliseconds. The least significant bitplane illumination periods, R0, G0, and B0, would be 300 microseconds each. If greater bit resolution were to be provided, or more bitplanes desired per color, the illumination periods corresponding to the least significant bitplanes would require even shorter periods, substantially less than 100 microseconds each.

It is useful, in the development or programming of the sequence controller 160, to co-locate or store all of the critical sequencing parameters governing expression of gray scale in a sequence table, sometimes referred to as the sequence table store. An example of a table representing the stored critical sequence parameters is listed below as Table 1. The sequence table lists, for each of the sub-frames or “fields” a relative addressing time (e.g. AT0, at which the loading of a bitplane begins), the memory location of associated bitplanes to be found in buffer memory 159 (e.g. location M0, M1, etc.), an identification codes for one of the lamps (e.g. R, G, or B), and a lamp time (e.g. LT0, which in this example determines that time at which the lamp is turned off).

TABLE 1
Sequence Table 1

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| addressing time | AT0 | AT1 | AT2 | AT3 | AT4 | AT5 | AT6 | . . . | AT(n − 1) | ATn |
| memory | M0 | M1 | M2 | M3 | M4 | M4 | M6 | . . . | M(n − 1) | Mn |
| location of sub- | | | | | | | | | | |
| frame data set | | | | | | | | | | |
| lamp ID | R | R | R | R | G | G | G | . . . | B | B |
| lamp time | LT0 | LT1 | LT2 | LT3 | LT4 | LT5 | LT6 | . . . | LT(n − 1) | LTn |

It is useful to co-locate the storage of parameters in the sequence table to facilitate an easy method for re-programming or altering the timing or sequence of events in a display process. For instance it is possible to re-arrange the order of the color sub-fields so that most of the red sub-fields are immediately followed by a green sub-field, and the green are immediately followed by a blue sub-field. Such rearrangement or interspersing of the color subfields increase the nominal frequency at which the illumination is switched between lamp colors, which reduces the impact of a perceptual imaging artifact known as color break-up. By switching between a number of different schedule tables stored in memory, or by re-programming of schedule tables, it is also possible to switch between processes requiring either a lesser or greater number of bitplanes per color—for instance by allowing the illumination of 8 bitplanes per color within the time of a single image frame. It is also possible to easily re-program the timing sequence to allow the inclusion of sub-fields corresponding to a fourth color LED, such as the white lamp 146.

The display process 500 establishes gray scale according to a coded word by associating each sub-frame image with a distinct illumination value based on the pulse width or illumination period in the lamps. Alternate methods are available for expressing illumination value. In one alternative, the illumination periods allocated for each of the sub-frame images are held constant and the amplitude or intensity of the illumination from the lamps is varied between sub-frame images according to the binary ratios 1,2,4,8, etc. For this implementation the format of the sequence table is changed to assign a unique lamp intensity for each of the sub-fields instead of a unique timing signal. In other embodiments of a display process both the variations of pulse duration and pulse amplitude from the lamps are employed and both specified in the sequence table to establish gray scale distinctions between sub-frame images. These and other alternative methods for expressing time domain gray scale using a timing controller are described in US Patent Application Publication No. US 20070205969 A1, published Sep. 6, 2007, incorporated herein by reference.

FIG. 6 is a timing diagram 600 that utilizes the parameters listed in Table 6. The timing diagram 600 corresponds to a coded-time division grayscale addressing process in which image frames are displayed by displaying four sub-frame images for each color component of the image frame. Each sub-frame image displayed of a given color is displayed at the same intensity for half as long a time period as the prior sub-frame image, thereby implementing a binary weighting scheme for the sub-frame images. The timing diagram 600 includes sub-frame images corresponding to the color white, in addition to the colors red, green and blue, that are illuminated using a white lamp. The addition of a white lamp allows the display to display brighter images or operate its lamps at lower power levels while maintaining the same brightness level. As brightness and power consumption are not linearly related, the lower illumination level operating mode, while providing equivalent image brightness, consumes less energy. In addition, white lamps are often more efficient, i.e. they consume less power than lamps of other colors to achieve the same brightness.

More specifically, the display of an image frame in timing diagram 600 begins upon the detection of a vsync pulse. As indicated on the timing diagram and in the Table 6 schedule table, the bitplane R3, stored beginning at memory location M0, is loaded into the array of light modulators 150 in an addressing event that begins at time AT0. Once the controller 134 outputs the last row data of a bitplane to the array of light modulators 150, the controller 134 outputs a global actuation command. After waiting the actuation time, the controller causes the red lamp to be illuminated. Since the actuation time is a constant for all sub-frame images, no corresponding time value needs to be stored in the schedule table store to determine this time. At time AT4, the controller 134 begins loading the first of the green bitplanes, G3, which, according to the schedule table, is stored beginning at memory location M4. At time AT8, the controller 134 begins loading the first of the blue bitplanes, B3, which, according to the schedule table, is stored beginning at memory location M8. At time AT12, the controller 134 begins loading the first of the white bitplanes, W3, which, according to the schedule table, is stored beginning at memory location M12. After completing the addressing corresponding to the first of the white bitplanes, W3, and after waiting the actuation time, the controller causes the white lamp to be illuminated for the first time.

Because all the bitplanes are to be illuminated for a period longer than the time it takes to load a bitplane into the array of light modulators 150, the controller 134 extinguishes the lamp illuminating a sub-frame image upon completion of an addressing event corresponding to the subsequent sub-frame image. For example, LT0 is set to occur at a time after AT0 which coincides with the completion of the loading of bitplane R2. LT1 is set to occur at a time after AT1 which coincides with the completion of the loading of bitplane R1.

The time period between vsync pulses in the timing diagram is indicated by the symbol FT, indicating a frame time. In some implementations the addressing times AT0, AT1, etc. as well as the lamp times LT0, LT1, etc. are designed to accomplish 4 sub-frame images for each of the 4 colors within a frame time FT of 16.6 milliseconds, i.e. according to a frame rate of 60 Hz. In other implementations the time values stored in the schedule table store can be altered to accomplish 4 sub-frame images per color within a frame time FT of 33.3 milliseconds, i.e. according to a frame rate of 30 Hz. In other implementations frame rates as low as 24 Hz may be employed or frame rates in excess of 100 Hz may be employed.

TABLE 6
Schedule Table 6

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| addressing time | AT0 | AT1 | AT2 | AT3 | AT4 | AT5 | AT6 | . . . | AT(n − 1) | ATn |
| memory | M0 | M1 | M2 | M3 | M4 | M4 | M6 | . . . | M(n − 1) | Mn |
| location of subframe | | | | | | | | | | |
| dataset | | | | | | | | | | |
| lamp ID | R | R | R | R | G | G | G | . . . | W | W |

The use of white lamps can improve the efficiency of the display. The use of four distinct colors in the sub-frame images requires changes to the data processing in the input processing module 1003. Instead of deriving bitplanes for each of 3 different colors, a display process according to timing diagram 600 requires bitplanes to be stored corresponding to each of 4 different colors. The input processing module 1003 may therefore convert the incoming pixel data, encoded for colors in a 3-color space, into color coordinates appropriate to a 4-color space before converting the data structure into bitplanes.

In addition to the red, green, blue, and white lamp combination, shown in timing diagram 600, other lamp combinations are possible which expand the space or gamut of achievable colors. A useful 4-color lamp combination with expanded color gamut is red, blue, true green (about 520 nm) plus parrot green (about 550 nm). Another 5-color combination which expands the color gamut is red, green, blue, cyan, and yellow. A 5-color analogue to the well known YIQ color space can be established with the lamps white, orange, blue, purple, and green. A 5-color analog to the well known YUV color space can be established with the lamps white, blue, yellow, red, and cyan.

Other lamp combinations are possible. For instance, a useful 6-color space can be established with the lamp colors red, green, blue, cyan, magenta, and yellow. A 6-color space can also be established with the colors white, cyan, magenta, yellow, orange, and green. A large number of other 4-color and 5-color combinations can be derived from amongst the colors already listed above. Further combinations of 6, 7, 8 or 9 lamps with different colors can be produced from the colors listed above. Additional colors may be employed using lamps with spectra which lie in between the colors listed above.

FIG. 7 is a timing diagram 700 that utilizes the parameters listed in the schedule table of Table 7. The timing diagram 700 corresponds to a hybrid coded-time division and intensity grayscale display process in which lamps of different colors may be illuminated simultaneously. Though each sub-frame image is illuminated by lamps of all colors, sub-frame images for a specific color are illuminated predominantly by the lamp of that color. For example, during illumination periods for red sub-frame images, the red lamp is illuminated at a higher intensity than the green lamp and the blue lamp. As brightness and power consumption are not linearly related, using multiple lamps each at a lower illumination level operating mode may require less power than achieving that same brightness using one lamp at an higher illumination level.

The sub-frame images corresponding to the least significant bitplanes are each illuminated for the same length of time as the prior sub-frame image, but at half the intensity. As such, the sub-frame images corresponding to the least significant bitplanes are illuminated for a period of time equal to or longer than that required to load a bitplane into the array.

TABLE 7
Schedule Table 7

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| data time | AT0 | AT1 | AT2 | AT3 | AT4 | AT5 | AT6 | . . . | AT(n − 1) | ATn |
| memory location | M0 | M1 | M2 | M3 | M4 | M5 | M6 | . . . | M(n − 1) | Mn |
| of subframe data set | | | | | | | | | | |
| red average intensity | RI0 | RI1 | RI2 | RI3 | RI4 | RI5 | RI6 | . . . | RI(n − 1) | Rn |
| green average | GI0 | GI1 | GI2 | GI3 | GI4 | GI5 | GI6 | . . . | GI(n − 1) | Gn |
| intensity | | | | | | | | | | |
| blue average | BI0 | BI1 | BI2 | BI3 | BI4 | BI5 | BI6 | . . . | BI(n − 1) | Bn |
| intensity | | | | | | | | | | |

More specifically, the display of an image frame in timing diagram 700 begins upon the detection of a vsync pulse. As indicated on the timing diagram and in the Table 7 schedule table, the bitplane R3, stored beginning at memory location M0, is loaded into the array of light modulators 150 in an addressing event that begins at time AT0. Once the controller 134 outputs the last row data of a bitplane to the array of light modulators 150, the controller 134 outputs a global actuation command. After waiting the actuation time, the controller causes the red, green and blue lamps to be illuminated at the intensity levels indicated by the Table 7 schedule, namely RI0, GI0 and BI0, respectively. Since the actuation time is a constant for all sub-frame images, no corresponding time value needs to be stored in the schedule table store to determine this time. At time AT1, the controller 134 begins loading the subsequent bitplane R2, which, according to the schedule table, is stored beginning at memory location M1, into the array of light modulators 150. The sub-frame image corresponding to bitplane R2, and later the one corresponding to bitplane R1, are each illuminated at the same set of intensity levels as for bitplane R1, as indicated by the Table 7 schedule. In comparison, the sub-frame image corresponding to the least significant bitplane R0, stored beginning at memory location M3, is illuminated at half the intensity level for each lamp. That is, intensity levels RI3, GI3 and BI3 are equal to half that of intensity levels RI0, GI0 and BI0, respectively. The process continues starting at time AT4, at which time bitplanes in which the green intensity predominates are displayed. Then, at time ATB, the controller 134 begins loading bitplanes in which the blue intensity dominates.

Because all the bitplanes are to be illuminated for a period longer than the time it takes to load a bitplane into the array of light modulators 150, the controller 134 extinguishes the lamp illuminating a sub-frame image upon completion of an addressing event corresponding to the subsequent sub-frame image. For example, LT0 is set to occur at a time after AT0 which coincides with the completion of the loading of bitplane R2. LT1 is set to occur at a time after AT1 which coincides with the completion of the loading of bitplane R1.

The mixing of color lamps within sub-frame images in timing diagram 700 can lead to improvements in power efficiency in the display. Color mixing can be particularly useful when images do not include highly saturated colors.

FIG. 8 is a block diagram of a controller, such as controller 134 of FIG. 1B, for use in a direct-view display, according to an illustrative embodiment of the invention. The controller 1000 includes an input processing module 1003, a memory control module 1004, a frame buffer 1005, a timing control module 1006, a pre-set imaging mode selector 1007, and a plurality of unique pre-set imaging mode stores 1009, 1010, 1011 and 1012, each containing data sufficient to implement a respective pre-set imaging mode. The controller also includes a switch 1008 responsive to the pre-set mode selector for switching between the various preset imaging modes. In some implementations the components may be provided as distinct chips or circuits which are connected together by means of circuit boards, cables, or other electrical interconnects. In other implementations several of these components can be designed together into a single semiconductor chip such that their boundaries are nearly indistinguishable except by function.

The controller 1000 receives an image signal 1001 from an external source, as well as host control data 1002 from the host device 120 and outputs both data and control signals for controlling light modulators and lamps of the display 128 into which it is incorporated.

The input processing module 1003 receives the image signal 1001 and processes the data encoded therein into a format suitable for displaying via the array of light modulators 100. The input processing module 1003 takes the data encoding each image frame and converts it into a series of sub-frame data sets. While in various embodiments, the input processing module 1003 may convert the image signal into non-coded sub-frame data sets, ternary coded sub-frame data sets, or other form of coded sub-frame data set, preferably, the input processing module converts the image signal into bitplanes, In addition, in some implementations, described further below in relation to FIG. 10, content providers and/or the host device encode additional information into the image signal 1001 to affect the selection of a pre-set imaging mode by the controller 1000. Such additional data is sometimes referred to a metadata. In such implementations, the input processing module 1003 identifies, extracts, and forwards this additional information to the pre-set imaging mode selector 1007 for processing.

The input processing module 1003 also outputs the sub-frame data sets to the memory control module 1004. The memory control module then stores the sub-frame data sets in the frame buffer 1005. The frame buffer is preferably a random access memory, although other types of serial memory can be used without departing from the scope of the invention. The memory control module 1004, in one implementation stores the sub-frame data set in a predetermined memory location based on the color and significance in a coding scheme of the sub-frame data set. In other implementations, the memory control module stores the sub-frame data set in a dynamically determined memory location and stores that location in a lookup table for later identification. In one particular implementation, the frame buffer 1005 is configured for the storage of bitplanes.

The memory control module 1004 is also responsible for, upon instruction from the timing control module 1006, retrieving sub-image data sets from the frame buffer 1005 and outputting them to the data drivers 132. The data drivers load the data output by the memory control module into the light modulators of the array of light modulators 100. The memory control module outputs the data in the sub-image data sets one row at a time. In one implementation, the frame buffer includes two buffers, whose roles alternate. While the memory control module stores newly generated bitplanes corresponding to a new image frame in one buffer, it extracts bitplanes corresponding to the previously received image frame from the other buffer for output to the array of light modulators. Both buffer memories can reside within the same circuit, distinguished only by address.

Data defining the operation of the display module for each of the pre-set imaging modes are stored in the pre-set imaging mode stores 1009, 1010, 1011, and 1012. Specifically, in one implementation, this data takes the form of a scheduling table, such as the scheduling tables described above in relation to FIGS. 5, 6 and 7. As described above, a scheduling table includes distinct timing values dictating the times at which data is loaded into the light modulators as well as when lamps are both illuminated and extinguished. In certain implementations, the pre-set imaging mode stores 1009-1012 store voltage and/or current magnitude values to control the brightness of the lamps. Collectively, the information stored in each of the pre-set imaging mode stores provide a choice between distinct imaging algorithms, for instance between display modes which differ in the properties of frame rate, lamp brightness, color temperature of the white point, bit levels used in the image, gamma correction, resolution, color gamut, achievable grayscale precision, or in the saturation of displayed colors. The storage of multiple pre-set mode tables, therefore, provides for flexibility in the method of displaying images, a flexibility which is especially advantageous when it provides a method for saving power for use in portable electronics. In some embodiments, the data defining the operation of the display module for each of the pre-set imaging modes are integrated into a baseband, media or applications processor, for example, by a corresponding IC company or by a consumer electronics OEM.

In another embodiment, not depicted in FIG. 8, memory (e.g. random access memory) is used to generically store the level of each color for any given image. This image data can be collected for a predetermined amount of image frames or elapsed time. The histogram provides a compact summarization of the distribution of data in an image. This information can be used by the pre-set imaging mode selector 1007 to select a pre-set imaging mode. This allows the controller 1000 to select future imaging modes based on information derived from previous images.

FIG. 9 is a flow chart of a process of displaying images 1100 suitable for use by a direct-view display such as the controller of FIG. 8, according to an illustrative embodiment of the invention. The display process 1100 begins with the receipt of mode selection data, i.e., data used by the pre-set imaging mode selector 1007 to select an operating mode (Step 1102). For example, in various embodiments, mode selection data includes, without limitation, one or more of the following types of data: a content type identifier, a host mode operation identifier, environmental sensor output data, user input data, host instruction data, and power supply level data. A content type identifier identifies the type of image being displayed. Illustrative image types include text, still images, video, web pages, computer animation, or an identifier of a software application generating the image. The host mode operation identifier identifies a mode of operation of the host. Such modes will vary based on the type of host device in which the controller is incorporated. For example, for a cell phone, illustrative operating modes include a telephone mode, a camera mode, a standby mode, a texting mode, a web browsing mode, and a video mode. Environmental sensor data includes signals from sensors such as photodetectors and thermal sensors. For example, the environmental data indicates levels of ambient light and temperature. User input data includes instructions provided by the user of the host device. This data may be programmed into software or controlled with hardware (e.g. a switch or dial). Host instruction data may include a plurality of instructions from the host device, such as a “shut down” or “turn on” signal. Power supply level data is communicated by the host processor and indicates the amount of power remaining in the host's power source.

Based on these data inputs, the pre-set imaging mode selector 1007 determines the appropriate pre-set imaging mode (Step 1104). For example, a selection is made between the pre-set imaging modes stored in the pre-set imaging mode stores 1009-1012. When the selection amongst pre-set imaging modes is made by the pre-set imaging mode selector, it can be made in response to the type of image to be displayed (for instance video or still images require finer levels of gray scale contrast versus an image which needs only a limited number of contrast levels (such as a text image)). Another factor which that might influence the selection of an imaging mode might be the lighting ambient of the device. For example, one might prefer one brightness for the display when viewed indoors or in an office environment versus outdoors where the display must compete in an environment of bright sunlight. Brighter displays are more likely to be viewable in an ambient of direct sunlight, but brighter displays consume greater amounts of power. The pre-set mode selector, when selecting pre-set imaging modes on the basis of ambient light, can make that decision in response to signals it receives through an incorporated photodetector. Another factor that might influence the selection of an imaging mode might be the level of stored energy in a battery powering the device in which the display is incorporated. As batteries near the end of their storage capacity it may be preferable to switch to an imaging mode which consumes less power to extend the life of the battery.

The selection step 1104 can be accomplished by means of a mechanical relay, which changes the reference within the timing control module 1006 to one of the four pre-set image mode stores 1009-1012. Alternately, the selection step 1104 can be accomplished by the receipt of an address code which indicates the location of one of the pre-set image mode stores 1009-1012. The timing control module 1006 then utilizes the selection address, as received through the switch control 1008, to indicate the correct location in memory for the pre-set imaging mode.

The process 1100 then continues with the receipt of the data for an image frame (step 1106). The data is received by the input processing module 1003 by means of the input line 1001. The input processing module then derives a plurality of sub-frame data sets, for instance bitplanes, and stores them in the frame buffer 1005 (step 1108). In some implementations, the number of bit planes generated depends on the selected mode. In addition, the content of each bit plane may also be based in part on the selected mode. After storage of the sub-frame data sets, the timing control module 1006 proceeds to display each of the sub-frame data sets, at step 1110, in their proper order and according to timing and intensity values stored in the pre-set imaging mode store.

The process 1100 repeats itself based on decision block 1112. For example, in one implementation, the controller executes process 1100 for an image frame received from the host processor. When the process reaches decision block 1112, instructions from the host processor indicate that the image mode does not need to be changed. The process 1100 then continues receiving subsequent image data at step 1106. In another implementation, when the process reaches decision block 1112, instructions from the host processor indicate that the image mode does need to change to a different pre-set mode. The process 1100 then begins again at step 1102 by receiving new pre-set imaging mode selection data. The sequence of receiving image data at step 1106 through the display of the sub-frame data sets at step 1110 can be repeated many times, where each image frame to be displayed is governed by the same selected pre-set image mode table. This process can continue until directions to change the imaging mode are received at decision block 1112. In an alternative embodiment, decision block 1112 may be executed only on a periodic basis, e.g., every 10 frames, 30 frames, 60 frames, or 90 frames. Or in another embodiment, the process begins again at step 1102 only after the receipt of an interrupt signal emanating from one or the other of the input processing module 1003 or the image mode selector 1007. An interrupt signal may be generated, for instance, whenever the host device makes a change between applications or after a substantial change in on of the environmental sensors.

FIG. 10 depicts a display method 1200 by which the controller 1000 can adapt the display characteristics based on the content of incoming image data. Referring to FIGS. 10 and 12, the display method 1200 begins with the receipt of the data for an image frame at step 1202. The data is received by the input processing module 1003 via the input line 1001. In one instance, at step 1204 the input processing module monitors and analyzes the content of the incoming image to look for an indicator of the type of content. For example, at step 1204 the input processing module would determine if the image signal contains text, video, still image, or web content. Based on the indicator the pre-set imaging mode selector 1007 would determine the appropriate pre-set mode in step 1206.

In another implementation, the image signal 1001 received by the input processing module 1003 includes header data encoded according to a codec for selection of pre-set display modes. The encoded data may contain multiple data fields including user defined input, type of content, type of image, or an identifier indicating the specific display mode to be used. In step 1204 the image processing module 1003 recognizes the encoded data and passes the information on to the pre-set imaging mode selector 1007. The pre-set mode selector then chooses the appropriate pre-set mode based on one or multiple sets of data in the codec (step 1206). The data in the header may also contain information pertaining to when a certain pre-set mode should be used. For example, the header data indicates that the pre-set mode be updated on a frame-by-frame basis, after a certain number of frames, or the pre-set mode should continue indefinitely until information indicates otherwise.

In step 1208 the input processing module 1003 derives a plurality of sub-frame data sets based on the pre-set imaging mode, for instance bitplanes, from the data and stores the bitplanes in the frame buffer 1005. After a complete image frame has been received and stored in the frame buffer 1005 the method 1200 proceeds to step 1210. Finally, at step 1210 the sequence timing control module 1006 assesses the instructions contained within the pre-set imaging mode store and sends signals to the drivers according to the ordering parameters and timing values that have been re-programmed within the pre-set image mode.

The method 1200 then continues iteratively with receipt of subsequent frames of image data. The processes of receiving (step 1202) and displaying image data (step 1210) may run in parallel, with one image being displayed from the data of one buffer memory according to the pre-set imaging mode at the same time that new sub-frame data sets are being analyzed and stored into a parallel buffer memory. The sequence of receiving image data at step 1202 through the display of the sub-frame data sets at step 1210 can be repeated interminably, where each image frame to be displayed is governed by a pre-set imaging mode.

It is instructive to consider some examples of how the method 1200 can reduce power consumption by choosing the appropriate pre-set imaging mode in response to data collected at step 1204. These examples are referred to as adaptive power schemes.

### EXAMPLE 1

A process is provided within the input processing module 1003 which determines whether the image is comprised solely of text or text plus symbols as opposed to video or a photographic image. The pre-set imaging mode selector can then select a pre-set mode accordingly. Text images, especially black and white text images, do not need to be refreshed as often as video images and typically require only a limited number of different colors or gray shades. The appropriate pre-set imaging mode can therefore adjust both the frame rate as well as the number of sub-images to be displayed for each image frame. Text images require fewer sub-images in the display process than photographic images.

### EXAMPLE 2

The pre-set imaging mode selector 1007 receives direct instructions from the host processor 122 to select a certain mode. For example, the host processor may directly tell the pre-set imaging mode selector to “use the limited color mode”.

### EXAMPLE 3

The pre-set imaging mode selector 1007 receives data from a photo sensor indicating low levels of ambient light. Because it is easier to see a display in low levels of ambient light, the pre-set imaging mode selector can choose a “dimmed lamp” pre-set mode in order to conserve power in a low-light environment.

### EXAMPLE 4

A specific pre-set mode could be selected based on the operating mode of the host. For instance, a signal from the host would indicate if it was in phone call mode, picture viewing mode, video mode, or on stand by and the pre-set mode selector would then decide on best pre-set mode to fit to the present state of the host. More specifically, different pre-set modes could be used for displaying text, video, icons, or web pages.

FIG. 11 is a block diagram of a controller, such as controller 134 of FIG. 1B, for use in a direct-view display, according to an illustrative embodiment of the invention. The controller 1300 includes an input processing module 1306, a memory control module 1308, a frame buffer 1310, a timing control module 1312, an imaging mode selector/parameter calculator 1314, and a pre-set imaging mode store 1316. The imaging mode store 1316 contains separate categories of sub modes including power, content and ambient sub modes. The “power” sub modes include “low” 1318, “medium” 1320, “high” 1322, and “full” 1324. The “content” sub modes include “text” 1326, “web” 1328, “video” 1330, and “still image” 1332. The “ambient” sub modes include “dark” 1334, “indoor” 1336, “outdoor” 1338, and “bright sun” 1340. These sub modes may be selectively combined to form a pre-set imaging mode with desired characteristics.

In some implementations the components may be provided as distinct chips or circuits which are connected together by means of circuit boards, cables, or other electrical interconnects. In other implementations several of these components can be designed together into a single semiconductor chip such that their boundaries are nearly indistinguishable except by function. The controller 1300 receives an image signal 1302 from an external source, as well as host control data 1304 from the host device 120 and outputs both data and control signals for controlling light modulators and lamps of the display 128 into which it is incorporated. The input processing module 1003 receives the image signal 1001 and processes the data encoded therein into a format suitable for displaying via the array of light modulators 100. The input processing module 1003 takes the data encoding each image frame and converts it into a series of sub-frame data sets. While in various embodiments, the input processing module 1003 may convert the image signal into non-coded sub-frame data sets, ternary coded sub-frame data sets, or other form of coded sub-frame data set, preferably, the input processing module converts the image signal into bitplanes. The input processing module 1003 also outputs the sub-frame data sets to the memory control module 1004. The memory control module then stores the sub-frame data sets in the frame buffer 1005. The frame buffer is preferably a random access memory, although other types of serial memory can be used without departing from the scope of the invention. The memory control module 1004, in one implementation stores the sub-frame data set in a predetermined memory location based on the color and significance in a coding scheme of the sub-frame data set. In other implementations, the memory control module stores the sub-frame data set in a dynamically determined memory location and stores that location in a lookup table for later identification. In one particular implementation, the frame buffer 1005 is configured for the storage of bitplanes.

The memory control module 1004 is also responsible for, upon instruction from the timing control module 1006, retrieving sub-image data sets from the frame buffer 1005 and outputting them to the data drivers 132. The data drivers load the data output by the memory control module into the light modulators of the array of light modulators 100. The memory control module outputs the data in the sub-image data sets one row at a time. In one implementation, the frame buffer includes two buffers, whose roles alternate. While the memory control module stores newly generated bitplanes corresponding to a new image frame in one buffer, it extracts bitplanes corresponding to the previously received image frame from the other buffer for output to the array of light modulators. Both buffer memories can reside within the same circuit, distinguished only by address.

Data defining the operation of the display module for each of the pre-set imaging modes are stored in the pre-set imaging mode store 1316. The pre-set imaging mode store is divided up into separate sub modes within different categories. In one embodiment, the categories include “power modes”, which specifically modify the image so that less power is consumed by the display, “content modes”, which contain specific instructions to display images based on the type of content, and “environmental modes”, which modify the image based on various environmental aspects, such as battery power level and ambient light and heat. For example, a sub mode in the “power modes” category may hold instructions for the use of lower illumination values for the lamps 140-146 in order to conserve power. A sub mode in the “content modes” category may hold instructions for a smaller color gamut, which would save power while adequately displaying images that do not require a large color gamut such as text. In the controller 1300, the imaging mode selector/parameter calculator 1314 selects a combination of imaging pre-set sub modes based on input image or host control data. The instructions of the combined pre-set imaging sub modes are then processed by imaging mode selector/parameter calculator 1314 to derive a schedule table and drive voltages for displaying the image. Alternatively, the preset imaging mode store 1316 may store preset imaging modes corresponding to various combinations of submodes. Each combination may be associated with its own imaging mode, or multiple combinations may be linked with the same preset imaging mode.

FIG. 12 is a flow chart of a process of displaying images 1400 suitable for use by a direct-view display controller such as the controller of FIG. 11, according to an illustrative embodiment of the invention. Referring to FIGS. 11 and 12, the display process 1400 begins with the receipt of image signal and host control data (step 1402). The imaging mode selector/parameter calculator 1314 then calculates a plurality of pre-set imaging sub modes based on the input data (step 1404). For example, in various embodiments, mode calculation data includes, without limitation, one or more of the following types of data: a content type identifier, a host mode operation identifier, environmental sensor output data, user input data, host instruction data, and power supply level data. The imaging parameter calculator has the ability to “mix and match” sub modes from different categories to obtain the desired imaging display mode. For example, if the host control data 1304 indicates that the host is in standby mode and the image data 1302 indicates a still image, the imaging mode selector/parameter calculator 1314 would select sub modes from the pre-set imaging mode store 1316 in the power modes category, to reduce power usage, and in the content modes category, to adjust the imaging parameters for a still image. In step 1406, the parameter calculator 1314, determines the proper timing and drive parameter values based on the selected sub modes.

In step 1408 the input processing module 1306 derives a plurality of sub-frame data sets based on the selected sub modes, for instance bitplanes, from the data and stores the bitplanes in the frame buffer 1310. After a complete image frame has been received and stored in the frame buffer 1310 the method 1400 proceeds to step 1410. Finally, at step 1410 the sequence timing control module 1312 assesses the instructions contained within the pre-set imaging mode store and sends signals to the drivers according to the ordering parameters and timing values that have been re-programmed within the plurality of selected pre-set imaging sub modes.

It is instructive to consider some examples of how the method 1400 can reduce power consumption by choosing the appropriate combination of pre-set imaging sub modes in response to data collected at step 1402.

### EXAMPLE 1

The imaging mode selector/parameter calculator 1314 receives data indicating low battery level and that the content type is text. The imaging mode selector/parameter calculator can then choose a combination of pre-set imaging sub modes such as “low” 1318 and “text” 1326 in order to display the text image in black and white in order to conserve battery power. In a similar instance, the imaging mode selector/parameter calculator 1314 receives data indicating medium battery level and that the content type is text. The imaging mode selector/parameter calculator can then choose a combination of pre-set imaging sub modes such as “medium” 1320 and “text” 1326 in order to display the text image in colors that are encoded in the image data, because adequate power is available to do so.

### EXAMPLE 2

The imaging mode selector/parameter calculator 1314 receives host data carrying a user preference for high frame rate for video content. In addition, the imaging mode selector/parameter calculator 1314 receives an indication from the host data of low battery power levels and an identifier from the image signal indicating video content. In this situation the imaging mode selector/parameter calculator 1314 can select the appropriate sub modes for high frame rate, in accordance with the user's preference for video content, and other power conserving sub modes which result in low color gamut, or reduced brightness to conserve battery levels.

FIG. 13 is a block diagram of a controller, such as controller 134 of FIG. 1B, for use in a direct-view display, according to an illustrative embodiment of the invention. The controller 1500 includes an input processing module 1506, a memory control module 1508, a frame buffer 1510, a timing control module 1512, an imaging mode selector/parameter calculator 1514, and a pre-set imaging mode store 1516. The image mode store 1516 is organized as a selection between components or partial specifications which, when combined, make up a pre-set imaging mode. The image mode store 1516 provides a menu of imaging mode characteristics (1518 through 1548) enabling, therefore, the image mode calculator 1514 to assemble various image mode characteristics into a complete specification of the pre-set mode for transmittal to the timing control 1512. The imaging mode store 1516 contains separate categories of image mode characteristics such as brightness, bit depth, color saturation, and gamma.

For example, the brightness variations included in the image mode store 1516 could specify the lamp luminosities that are consistent with a display providing 150, 250 400, or 800 candelas per meter squared brightness. The various bit depths for imaging modes supported in the image mode store can include 1, 6, 9, 12, 18, or 24 bits per pixel. The choices for color saturation can be 120% of NTSC colors, 90% of NTSC colors, saturation equivalent to an sRGB color space, or 65% of the sRGB color space. The choices of gamma can be 1, 1.8, 2.2, or 2.4. Other menu choices can also be available within the image mode store 1516. These include variations the color temperature of the white point, edge sharpening and/or dithering algorithms, and variations in image frame rate.

These imaging characteristics may be selectively combined within the image mode calculator 1514 to form a pre-set imaging mode with desired characteristics. In some implementations the components may be provided as distinct chips or circuits which are connected together by means of circuit boards, cables, or other electrical interconnects. In other implementations several of these components can be designed together into a single semiconductor chip such that their boundaries are nearly indistinguishable except by function.

The controller 1500 receives an image signal 1502 from an external source, as well as host control data 1504 from the host device 120 and outputs both data and control signals for controlling light modulators and lamps of the display 128 into which it is incorporated. The input processing module 1003 receives the image signal 1001 and processes the data encoded therein into a format suitable for displaying via the array of light modulators 100. The input processing module 1003 takes the data encoding each image frame and converts it into a series of sub-frame data sets. While in various embodiments, the input processing module 1003 may convert the image signal into non-coded sub-frame data sets, ternary coded sub-frame data sets, or other form of coded sub-frame data set, preferably, the input processing module converts the image signal into bitplanes. The input processing module 1003 also outputs the sub-frame data sets to the memory control module 1004. The memory control module then stores the sub-frame data sets in the frame buffer 1005. The frame buffer is preferably a random access memory, although other types of serial memory can be used without departing from the scope of the invention. The memory control module 1004, in one implementation stores the sub-frame data set in a predetermined memory location based on the color and significance in a coding scheme of the sub-frame data set. In other implementations, the memory control module stores the sub-frame data set in a dynamically determined memory location and stores that location in a lookup table for later identification. In one particular implementation, the frame buffer 1005 is configured for the storage of bitplanes.

The memory control module 1004 is also responsible for, upon instruction from the timing control module 1006, retrieving sub-image data sets from the frame buffer 1005 and outputting them to the data drivers 152. The data drivers load the data output by the memory control module into the light modulators of the array of light modulators 100. The memory control module outputs the data in the sub-image data sets one row at a time. In one implementation, the frame buffer includes two buffers, whose roles alternate. While the memory control module stores newly generated bitplanes corresponding to a new image frame in one buffer, it extracts bitplanes corresponding to the previously received image frame from the other buffer for output to the array of light modulators. Both buffer memories can reside within the same circuit, distinguished only by address.

Data defining the operation of the display module for each of the pre-set imaging modes are stored in the pre-set imaging mode store 1516 as described above. In the controller 1500, the imaging mode selector/parameter calculator 1514 includes a look-up table which links combination of operational, content, and environmental data values to specific imaging characteristics stored in the pre-set imaging mode store 1516. The operational, content, and environmental data values are obtained from the host data control 1504 and the input processing module 1506. The parameter calculator 1514 selects and processes the combination of imaging characteristics identified in the look up table to derive a schedule table and drive voltages for displaying the image.

The process for displaying images according to controller 1500 is similar to that described for controller 1300. Referring to FIGS. 12 and 13, the display process 1400 begins with the receipt of image signal and host control data (step 1402). The imaging mode selector/parameter calculator 1514 then calculates a plurality of pre-set imaging characteristics (1518 through 1548) based on the input data (step 1404). For example, in various embodiments, mode calculation data includes, without limitation, one or more of the following types of data: a content type identifier, a host mode operation identifier, environmental sensor output data, user input data, host instruction data, and power supply level data. The imaging parameter calculator has the ability to “mix and match” characteristics from different categories, for instance using a multi-variable lookup table, to obtain the desired imaging display mode. In step 1406, the parameter calculator 1514, determines the proper timing and drive parameter values based on the selected imaging characteristics, and outputs those to the timing control module 1512. The display of the image then proceeds as described above in steps 1408 and 1410.

### Embodiments Utilizing Pre-Set Imaging Modes

### Embodiment 1: The 24 Bit Reference Mode

It is instructive to describe a variety of possible pre-set imaging modes that have advantages when displaying different types of information. For reference, the various imaging modes will be compared a 1^{st} embodiment of the invention which is a high quality imaging mode where video and photographic images are processed and displayed with 24 digital bits of information for each pixel (also referred to as 24 bpp, or as 24-bit truecolor), and where the color space conforms to the sRGB standard. (The sRGB standard is also referred to as the IEC 61966-2-1 standard.) The sRGB standard color space utilizes the same three primary colors specified for high-definition television, as in the ITU-R BT.709-5 or “Rec 709” specification. The x-y chromaticity coordinates (using the CIE 1931 metric) for the sRGB red, green, and blue primaries in the are given in Table 8 below. The x-y chromaticities given for the white point in the sRGB standard is chosen as the 6500K correlated color temperature, also referred to as the D65 white point.

TABLE 8
CIE 1931 color
primaries for the sRGB color space

| Chromaticity | Red | Green | Blue | White point |
|---|---|---|---|---|
| x | 0.6400 | 0.3000 | 0.1500 | 0.3127 |
| y | 0.3300 | 0.6000 | 0.0600 | 0.3290 |

The sRGB color space also specifies a gamma or transfer function specification, and those skilled in the art will recognize the sRGB gamma as a power law that is approximately 2.2, where additionally a linear transfer region is imposed below a certain luminance threshold.

A display that incorporates field sequential color can display the sRGB color space by mixing of the radiation from individual red, green, and blue lamps. In a preferred embodiment the display of this invention incorporates lamps, e.g. LEDs, with primary colors that are more saturated than those required to produce the sRGB primaries of Table 8. For instance, LEDs are available with x-y chromaticity coordinates corresponding to those in Table 9.

TABLE 9
CIE 1931 chromaticities
for exemplary LEDs in this embodiment

| Chromaticity | Red | Green | Blue | White point |
|---|---|---|---|---|
| x | 0.7023 | 0.2009 | 0.1423 | 0.3127 |
| y | 0.2964 | 0.7418 | 0.0365 | 0.3290 |

A plot of the LED color points from Table 9, using the CIE chromaticity coordinates is given in FIG. 14. Also illustrated in FIG. 14 are the standard sRGB chromaticities, listed in Table 10. It is apparent that the sRGB colors are less saturated than those made available by the LEDs.

In order to produce one of the sRGB primary colors from Table 8 using the particular LEDs of Table 9, the display controller, e.g. controller 134, provides a distinct set of control signals to the lamp drivers, e.g. drivers 148, such that a particular mixture of illumination values is output from the lamps, e.g. LEDs 140, 142, and 144, during each of the sub-frame images in the sequence. An exemplary sub-frame timing sequence is illustrated by display process 500 of FIG. 5. In order to produce, for example, an illumination corresponding to the standard sRGB green chromaticity, it is preferred to mix in some LED red, and LED blue light along with the LED green light during the time of the green color sub-field. To display the sRGB color primaries then, the colors of the color sub-fields are effectively de-saturated with respect to the chromaticities available from the LEDs in Table 9, by mixing in small but predetermined amounts of light from the other two colors. In order to determine the correct color-mixing ratios required to produce color sub-fields with the standard sRGB color points, the designer will make use of the chromaticities shown in Tables 8 and 9 along with corresponding data on LED luminosities (or the Y components of their tri-stimulus values). The methods for calculating the LED mixing ratios to produce appropriate colors and white points are well known to those skilled in the art.

The display process 500 shown in FIG. 5 illustrates the use of binary time division multiplexing, including the display of only 4 sub-frame images for each color within a single image frame. In order to display the high quality 24 bpp images referred to here as a reference imaging mode, the timing sequence would include the display of at least 24 binary sub-frame images within an image frame, corresponding to 24 unique sub-frame data sets or bitplanes, including 8 bitplanes for each of the red, green, and blue primary colors respectively. For many preferred algorithms, even more than 24 sub-frame images would be deployed in the sequence, particularly when techniques such as bit splitting are employed. Bit splitting is a technique whereby the most significant (or the longest time duration) bitplanes are split and displayed multiple times during a given image frame. The use of bit splitting helps reduce the severity of an artifact known as color breakup, as was described in co-pending US Patent Application Publication No. US 20070205969 A1, published Sep. 6, 2007, incorporated herein by reference.

### Embodiment 2: 24 Bits Per Pixel with Extended Color Gamut

Future multimedia devices may be optimized for display of extended color gamuts, incorporating colors that lie significantly beyond the color space defined by the sRGB standard. One such extended color gamut is in use today, whereby computers encode images with use of the Adobe RGB color space. The Adobe RGB color space employs red, green, and blue primaries that are more heavily saturated than those standardized by the sRGB color space. The x-y chromaticities of the Adobe RGB color space are given in Table 10, and illustrated in FIG. 14.

TABLE 10
CIE 1931 color primaries
for the Adobe RGB color space

| Chromaticity | Red | Green | Blue | White point |
|---|---|---|---|---|
| x | 0.6400 | 0.2100 | 0.1500 | 0.3127 |
| y | 0.3300 | 0.7100 | 0.0600 | 0.3290 |

The Adobe RGB color space can be incorporated for the field sequential displays of this invention as a pre-set image mode, according to a 2d embodiment of the invention. The chromaticities for the primary red, green, and blue colors given in Table 10 arc still less saturated than those available from the LEDs listed in Table 9. Therefore, the display of an image encoded for display with the Adobe RGB space can be accomplished by mixing radiation from the LEDs of Table 9 in a manner analogous to what was described for display of sRGB images above. Those skilled in the art will be able to determine the correct proportions of radiation from the red, green, and blue LEDs such that the illumination of each sub-frame image corresponds to the chromaticities of one of the Adobe RGB primaries.

The proportions of LED radiation sufficient to produce the Adobe RGB primaries will be different from the proportions used to produce the sRGB primaries. These respective proportions can be stored in the controller as part of a parameter set defining particular pre-set imaging modes. For instance the pre-set image store 1, labeled 1009 in FIG. 8, could include the lamp radiation proportions appropriate to an sRGB color space, while the pre-set image store 1, labeled 1010, could include lamp proportions appropriate to the Adobe RGB color space. The controller can switch between the display of the two different color spaces in response to a command or parameter received via the host control data 1002. Since the image signal received at input 1001 is likely to be similar in each of these two color examples, for instance including 24 bits per pixel, it is important that the controller have a means of identifying the intended color space for display. The identification of the particular color space encoded in the image signal can be provided either by a command received within the host control data or by metadata that is included, for instance as packet or frame header information, within the image signal itself.

A variety of other alternate color spaces have been proposed that employ extended color gamuts, and an alternate encoding scheme, referred to as the xvYcc coding scheme has been adopted recently to enable the transmission and display of extended color gamuts. The xvYcc encoding scheme is flexible enough to support a range of alternate primary colors with different saturations, although it is still predicated on a color space built from only 3 primary colors. As long as the host control data identifies the preferred and particular set of primary colors to be employed in the display, the display controllers of this invention are capable of computing the appropriate mixing of LED lamps to achieve color sub-fields with those primary colors. In a particular embodiment, a color space can be defined that incorporates the LED chromaticities directly, e.g. those listed in Table 9, as the primary colors. The color space with maximum available saturation or gamut for the display will be defined by the chromaticities of the particular lamps used in that display. The color space represented by Table 9 is calculated to cover 120% of the 1953 NTSC color space.

In other embodiments of this invention, a wide variety of alternate LEDs can be employed with color saturations intermediate between those described in Table 9 and those that would correspond more closely to the sRGB color space. In some cases the chromaticities of the LEDs are subject to variability based on the manufacturing process. In some embodiments, the pre-set image modes include mixing ratios for the LEDs that reflect calibration data particular to the individual display.

Generally speaking, to maintain the fidelity of an image for a viewer, it is important that the display present the same primary colors as those that were assumed or established during the recording, synthesis and/or transmission of the data in the image. Most digital cameras, in fact, are calibrated for recording with reference to one or, in some cases, either of the sRGB or Adobe RGB color formats. The standards definitions of these color spaces were established to provide consistency in image reproduction. If an Adobe RGB space were to be selected as the imaging mode in the display for a photograph was recorded in the sRGB format, then the resulting colors may appear exaggerated or over-saturated; some pictures would appear unreal or cartoonish, and the overall image will take on a reddish tint. If, conversely, the sRGB color space were to be selected as the pre-set mode for an image that had been synthesized or recorded with the Adobe RGB format, then the resulting colors can look muted, under-saturated, or washed out, and the image will take on a greenish tint.

Nevertheless, there are reasons by which a particular user, or the designer or a particular device application, may choose to employ a particular gamut or color space for display regardless of the color space encoded into the image data. Pre-set image modes may be chosen, in other words, where the color sub-fields are intentionally under-saturated or over-saturated with respect to one of the standard color spaces. There is a trade-off for instance between color saturation and image brightness. Therefore, in an alternative embodiment, a particular proportion of mixed colors in the lamps might be stored as a pre-set image mode. This pre-set mode would provide primary color fields with hues that are similar to the sRGB color space but with less saturation than is expected in the sRGB color space. This image mode would be chosen so the display will provide a brighter image, even though the colors would be desaturated.

Conversely, in an alternative embodiment, a pre-set mode can be established with the maximum gamut supported by the LEDs in the display, i.e. wherein the sub-frame images are illuminated by single red, green, or blue LEDs without mixing with the other colors. Images that are displayed with these maximum or even over-saturated colors can enhance the apparent contrast of an image, which can be an advantage for hard to read graphics (e.g. maps) and/or text images.

In another variation on the 24-bit reference imaging mode, pre-set image modes can be provided that give the user or device designer access to alternative gamma or image transfer functions. For instance, while gammas of 2.2 are common in many standard image formats, some graphical designers prefer to process images with gammas of 1.8 or 2.4. If the image data was loaded to the display along with a tagging code that identified the image encoding to a gamma of, for instance, 2.4 the displays of this invention would be able to adapt. Alternately, some viewers may also choose to arbitrarily increase or decrease the gammas employed in the production of an image, with higher gammas providing a deeper apparent contrast while smaller gammas are used to enhance faint background details in an image.

### Embodiment 3: 18 Bits Per Pixel, with Optional Reduced Color Gamut

Many portable devices utilize imagery that employs data encoded for only 16 bits per pixel, sometimes referred to as 16 bpp data formats or highcolor, as opposed to the 24-bit truecolor described with respect to embodiments 1 and 2 above. (The “number of bits per pixel” will also be equivalently referred to herein as the color resolution of an imaging mode, or as the bit depth of the imaging mode.) In some embodiments of a 16 bpp data set for images, only 5 bits of color information or resolution are provided for each of the colors red, green, and blue. Highcolor images can be found in devices that use less expensive 16 bit processors for image processing. And for gaming applications the use of 16 bpp color is preferred in order to increase the frame rates or processing speeds available for 3-dimensional rendering. A pre-set imaging mode optimized for use with 3D graphics can be designed to be compatible with 16 bpp color. For this 3d embodiment of a pre-set imaging mode, 18 bitplanes are displayed in a time division grayscale device within each image frame (referred to herein as the 18 bpp pre-set imaging mode). Six sub-frame images would be illuminated in this embodiment for each of the colors in the image frame, with their illumination values scaled according to binary coding. (For illustration, see the 4 bitplane per color example in display process 500.) The pre-set imaging mode would include the storage of parameters for its own timing sequence including trigger points for each of the 18 bitplanes are arranged within the period of the image frame.

A display of 18 bitplanes per image frame would appear to provide more bitplanes than is necessary if the encoded image only included only 5 bits of data per color. The use of an additional bitplane per color in the imaging mode, however, can be a useful method of displaying additional information for the image, such as a more accurate representation of the preferred gamma or luminance transfer function.

The controllers in the displays of this invention can be configured to detecting the presence of 16 bpp data in the image signal, either by analyzing data within the image signal itself or by following commands received via the host control data. By switching from a 24 bpp imaging mode to a pre-set mode that includes the display of only 18 bits per pixel imaging mode the display can reduce its operating power. The display can save the energy that would be required to load the data into the modulator array for 6 bitplanes in each of the image frames.

A pre-set imaging mode that allows for the display of 18 bits per pixel is capable of displaying 262,000 unique colors. Although the human eye is capable of distinguishing between more than 1 million different colors, in practice it is sometimes difficult for a viewer to tell the difference between an image that is encoded with 18 bits per pixel as opposed to 24 bit per pixel. For this reason, a pre-set mode that allows for 18 bits per pixel can be an economical choice or a power-saving method for displaying 24 bpp image files, despite the fact that some information will be lost. Only the 2 least significant bits of information will be discarded for each of color in a 24 bpp data set in this embodiment, so that the effect on a viewers perception of the image can be negligible.

A pre-set imaging mode that employs 18 bits per pixel in a time division grayscale display can be particularly effective for the display of multi-media information on a portable handheld device. When a device is configured for receiving information through the internet, as when the device employs a web browser, the information to be displayed is commonly a mix of control buttons or icons, text, simple graphics, and/or small format photographs. Little fidelity is lost by displaying this content in the 18 bits per pixel mode. The portable device can be programmed to inform the display controller, by means of host control data link such as link 1002, whenever the host launches a web browser application, so that the display controller can switch into the 18 bit pre-set mode. At a later time, after the user has downloaded a set of photographs or videos, the user can switch the device back into one of the 24 bit pre-set modes for optimal viewing of larger format photographs or videos.

A portable device configured with an 18 bit pre-set imaging mode according to this embodiment can be optionally programmed to include the intentional desaturation of image colors (the choice of a reduced color gamut). The pre-set parameter set provides for the mixing of the LED radiation within the color fields, enabling a variety of color spaces with different saturation values. A display generally provides a brighter image with the consumption of less power if a desaturated color space is chosen. In one embodiment the desaturated colors are produced by mixing in small proportions of 2 secondary colors along with the primary color in each color subfield. In another embodiment, the radiation from a 4th LED with white color can be mixed into the color sub-fields that are otherwise assigned to the red, green, and blue bitplanes, effectively de-saturating the color sub-fields.

By de-saturating the color sub-fields the display can economize on power for applications such as web browsing. The color gamut can be reduced to a range between 50% and 90% of the sRGB values as part of the 18 bit pre-set mode. The desaturated pre-set mode is of particular value for outdoor use where brighter displays are needed. Should the user choose to view photos or videos with more fidelity, he can always choose another pre-set mode where the color saturation matches that of the sRGB color space.

In an alternate embodiment of the invention, a pre-set imaging mode can configured to display only 15 bits of color per pixel. A 15 bits per pixel pre-set mode would be compatible with the data sets that are encoded for only 5 bits of color resolution in each color. In the 15 bpp pre-set mode, only 15 unique bitplanes would be displayed in a time division grayscale device within each image frame.

In an alternate embodiment of the invention, a pre-set imaging mode can configured to display only 16 bits of color per pixel. Some imaging applications have adopted a color coding scheme that employs 16 bits per pixel. In this coding scheme, the digital word for each pixel includes 5 bit levels for red, 6 bit levels for green, and 5 bit levels for blue. In the 16 bpp pre-set imaging mode a sub-frame image would be displayed corresponding to each of the 16 place values in the coded word. The 16 bpp pre-set image mode can be slightly more power efficient than the 18 bpp pre-set imaging mode described above.

### Embodiment 4: 9 Bits (Truecolor) per Pixel with Optional Extended Color Gamut

Many computer applications have been adopted for portable devices where the data sets incorporate only 8 bits per pixel. Such data sets and their associated images were, at one point in time, standard, since early data processors were only capable handling 8 bits per pixel. This situation continued into the 1990s, even though computer monitors at the time, such as CRTs, were capable of displaying much higher color resolution. Today many applications remain where the use of color spaces with only 8 bits per pixel is still considered sufficient or even preferred. A pre-set imaging mode is possible, therefore, as a 4th embodiment of this invention that provides for the display of only 9 bits per pixel in time division grayscale. For this 4th embodiment, 3 bitplanes with binary coding for each of the colors red, green, and blue are scheduled for display within each image frame. For reference, the data set employed to specify the colors of this pre-set imaging mode can be illustrated as follows:

(R₀, R₁, R₂, G₀, G₁, G₂, B₀, B₁, B₂)

Binary Word for Specifying Color Points in a 9 Bit Truecolor Imaging Mode

Where Ri, Gi, and Bi refer to various bit levels for the colors red, green, and blue respectively. In time division grayscale embodiments, at least one sub-frame image corresponding to each of the bits in the above coded word will be illuminated within the period of each image frame.

By reducing the number of bitplanes displayed in each image frame the display can reduce its power consumption. It is therefore an advantage to define a pre-set imaging mode, such as this 9-bit embodiment of the invention, by which the display controller provides to the display substantially the same number (or only slightly more) bits of resolution in the image as are required to reproduce the color resolution which is contained within the image data received by the display. This embodiment of the invention can be useful as well for displays that employ analog gray scale in their images, such as the OCB mode liquid crystal display illustrated in FIG. 2C, since the power consumption of the display can be reduced when the controller restricts the volume of transferred data, i.e. when it restricts the number of bits transmitted to the display drivers or to the modulator array. For instance, if only 8 bits per pixel of information is received in the incoming image signal, the display can reduce its power consumption by transmitting substantially only the same number of bits per pixel to the analog modulator array.

This 4^{th} embodiment refers to the use of only 9 bits of color information per pixel and per image frame. And an image frame refers to the time period between refreshes of the incoming signal data, designated commonly by the time periods between vsync pulses at the display. For a consistent reference then, the names of the pre-set modes in this invention are used to signify the number of bits per pixel displayed in a frame without accounting for additional bits that might be expressed through spatial or temporal dithering. Spatial and temporal dithering represent an optional means to supplement the color resolution of an image with extra bits of information, by either averaging color values between neighboring pixels or by averaging between sequential image frames. Displays that employ binary time division gray scale commonly incorporate spatial and temporal dithering. The extra bits are often used, however, merely for the purpose of expressing the gamma characteristic of the incoming data. Binary grayscale displays posses an inherently linear transfer function, and the dithered bits can be used to reproduce the non-linear luminance characteristics for gammas greater than one.

Despite advancements in computer processor speed, for many portable device applications the processing of an image with only 8 bits of color information per pixel is still sufficient or preferred. Many computer games available for free download from the Internet rely on the processing of only 8 bits per pixel. Many three-dimensional animation programs, including games with 3D or vector graphics, can run faster on inexpensive portable processors when they are restricted to the processing of only 8 bits of color resolution per pixel. Many maps, as displayed by global positioning systems (GPS), are best displayed in a simple graphical format that is limited to 8 bits of color per pixel. And many business or engineering applications, such as document viewers, control panels, or word processors, or spreadsheets, are imaged with sufficient quality by using only 8 bits of color per pixel. It is an advantage, therefore, for the display to be able to economize on power by adopting to the data requirements of a particular portable application. As described above, there are many methods by which the display can recognize the need or opportunity to reduce the number of bits per pixel in the display. The display controller may respond to a user command, where the controller allows the user to select the lower number of bits per pixel. Or the controller can receive a decision indicator as part of the host control data. For instance the host controller can send an explicit command by which the display controller is caused to switch into a 9 bit per pixel pre-set mode. Or the host controller can simply send an indicator or signal that the host device has entered a gaming application or a GPS or mapping application, or a document viewing application, based upon which the display controller makes its own decision to switch into the 9 bit per pixel imaging mode. This decision process was described with respect to the imaging mode selector/parameter calculator 1314. In an alternate embodiment, the display controller can analyze the incoming signal data itself to determine that the input signal contains only 8 bits per pixel. After this determination, the display control can enable the 9 bit per pixel pre-set imaging mode.

In an alternative embodiment, the pre-set imaging mode can be configured to display only 8 bits of data per pixel using truecolor coordinates. In this mode, the controller displays 3 bits of red, 3 bits of green, and but only 2 bits of resolution for the blue. (Truecolor as defined here means that the pixel data makes reference to red, green, and blue color coordinates and employs binary coding.) The 8-bit embodiment of a pre-set mode is appropriate for applications that process the data with the same 8 bit truecolor coding scheme. The coded word can be expressed as:

(R₀, R₁, R₂, G₀, G₁, G₂, B₀, B₁)

Binary Word for Specifying Color Points in a 8 Bit Truecolor Imaging Mode

In time division grayscale embodiments, at least one sub-frame image corresponding to each of the bits in the above coded word will be illuminated within the period of each image frame.

Many 8 bpp computer applications, however, do not employ truecolor coding for color data in the pixels. Instead, many applications which process and store 8 bits per pixel make reference to an independently defined color palette. Such applications use the 8-bit words at every pixel as an index or reference number for specifying a particular color out a set or color palette. Such color schemes are referred to as indexed color. In an 8 bit index scheme a full palette can contain as many as 256 unique colors. In an indexed color application, software is employed in a display driver for converting color indices into truecolor coordinates, such as the sRGB binary coordinates that a display would understand, by means of a color look-up table (CLUT). For 9 bit per pixel pre-set imaging mode the color data which is input to the CLUT would contain 8 index bits for each pixel, while the output data for developing an image on the display would include 9 truecolor coordinate bits for each pixel.

Some care must be exercised, however, before choosing a 9-bit truecolor pre-set imaging mode for use with an indexed color application. For many of these applications, the 9 bit per pixel pre-set imaging mode described here may unfavorably restrict the color choices in the palette. The 9 bit per pixel (truecolor) imaging mode presupposes a binary relationship between bits for display in each color, and although the 9 bit pre-set imaging mode for the display is capable of producing 512 colors, the resulting chromaticity of these colors (in relation to the primaries) is fixed by the coding in the 9 bit word. Therefore in this embodiment any color palette which indexes to a set of 256 colors must choose those colors from an available super-set of only 512 colors.

Still, for some indexed color applications, the 9 bit per pixel (truecolor) pre-set embodiment is sufficient and even a preferred low-power mode of display operation. For many applications the particular chromaticities of the colors to be displayed is of secondary importance, and most of the visual utility is retained even if the color palette is restricted to a choice from the 512 colors supported in the pre-set mode.

In one useful embodiment, the color space for the 9 bit per pixel (truecolor) pre-set mode is specified and displayed using the fully saturated set of primary colors, such as the primaries represented by the LEDs in Table 9. While still restricted to 512 colors, the color gamut encompassed by these LED primaries extends far beyond what is normally available in an sRGB color space. For many 8 bpp computer applications, the highly saturated 512 colors available in this extended-gamut pre-set mode will enhance the perceived contrast in the display. The 9 bit per pixel (truecolor) and extended gamut pre-set imaging mode is particularly useful for mapping or graphics applications where only a small number of distinct colors is required, but where the perceived contrast between the colors is at a premium.

In some embodiments, 9 bit color and reduced color gamut is used to achieve very high display brightness. For example, the display brightness mode may be used to achieve equal brightness to an LCD at much lower power consumption. In another embodiment, a pre-set mode may be used to achieve very high brightness (e.g., 2-3× an LCD) at the same power as a lower brightness LCD. For example, a pre-set display mode may be used to set low bit depth, low color gamut, and very high brightness.

### Embodiment 5: 12 Bits per Pixel (Truecolor) for Use with Truecolor Imaging Data

A pre-set imaging mode can also include the display of 12 bits of color data per pixel, according to a 5^{th} illustrative embodiment of the invention. In this 5^{th} embodiment, 12 unique bitplanes are displayed in a time division grayscale device within each image frame. Four sub-frame images would be illuminated in this embodiment for each of the colors red, green, and blue in the image frame, with their illumination values scaled according to binary coding. The color space employed for this 12 bit pre-set mode can be defined by the sRGB primary colors or a more saturated color gamut can be established by using the primary chromaticities available directly from the LED lamps. The 12 bit pre-set mode will consume considerably less power than that required to drive the 18 bit pre-set mode described above, since fewer sub-frame data sets need to be loaded into the modulator array during each image frame. The coded word that specifies colors for a 12-bit truecolor pre-set mode can be expressed as:

(R₀, R₁, R₂, R₃, G₀, G₁, G₂, G₃, B₀, B₁ B₂, B₃,)

In time division grayscale embodiments, at least one sub-frame image corresponding to each of the 12 bits in the above coded word will be illuminated within the period of each image frame.

A de-saturated color space (meaning less saturation than is specified by the sRGB standard) can also be provided in an alternate version of this pre-set mode by mixing radiation from the 3-color LEDs within each of the color sub-fields. Such a desaturated color space provides a brighter display for use in outdoor environments.

Graphical data sets that employ 12 bit per pixel are not very common. However, this 12 bit pre-set mode can be easily operated in conjunction with any 16 bpp highcolor image data or even 24 bpp truecolor image data simply by stripping away or ignoring all bits except for the most significant 4 bits in each color. The 12 bit per pixel pre-set mode can be particularly economical and effective for the display of 3D computer games and animations. Animated images tend to make use of fewer colors and more widely spaced or saturated colors than is the case for images taken directly from nature or from human subjects, and so the computer animations will tend to show fewer artifacts when reduced in resolution for display with only 12 bits per pixel.

A color-rich data set, such as 24 bpp video, can be displayed effectively using the 12 bit per pixel pre-set mode, although an artifact called banding can occur wherein distinct boundaries become visible between image regions with small variations in color. The displays in this embodiment can reduce banding artifacts for such applications in two ways: Temporal and spatial dithering can be used to display a range of intermediate colors in the banded area. In a dithering process, effectively, the averaging of data between pixels or between image frames is a way to incorporate information from extra bit levels in the data. And in the 2d method, the gamma coefficient can be reduced as part of the specification for the 12 bit pre-set mode, which reduces the luminance differences that are perceived between small variations in color.

### Embodiment 6: 12 Bits per Pixel (Truecolor) for Use with Indexed Color Applications

Another pre-set imaging mode incorporates the display of 12 bits of color data per pixel, according to a 6^{th} illustrative embodiment of the invention. In this 6^{th} embodiment, 12 unique bitplanes are displayed in a time division grayscale device within each image frame. Four sub-frame images would be illuminated for each of the colors red, green, and blue in the image frame, with their illumination values scaled according to binary coding. The color space employed for this 12 bit pre-set mode can be defined by the sRGB primary colors or a more saturated color gamut can be established by using the primary chromaticities available directly from the LED lamps.

This 6^{th} embodiment is particularly defined for use in for portable computer applications that employ 8 bit indexed color data sets. In an 8 bit indexed color application the computer processes and stores data for images which include at most 256 unique colors. The colors in the 256 color set, called the color palette, can be converted into truecolor coordinates (for driving a display) by means of a color lookup table (CLUT).

The 12 bpp truecolor imaging mode makes 4,096 distinct colors available to the viewer. Therefore the 12 bpp pre-set mode can be very effective at reproducing the particular colors that are defined by the color palette in an indexing scheme, particularly for so-called master palettes.

Color palettes come in two varieties: adaptive palettes and master palettes. An adaptive palette can be employed for the compressed digitization of photographs and images, where the software that creates the file, such as a .gif file or a .tif file, identifies a custom set of 256 colors that best fits the image. The CLUT for that optimized set of 256 colors is derived, stored, and transmitted along with the digitized image as part of its header information. In this fashion a photograph that originally may have included many of the 16 million available colors (24 bits per pixel) can be reduced in size and stored with only 8 bits per pixel. In order to reproduce the .gif image or the .tif image with fidelity, however, it is preferable if the display drivers can support the display of a larger superset of colors, preferably using the same color resolution (16 or 24 bits per color) as existed in the original image.

Master palettes, on the other hand, are employed by programs such as web browsers that assemble images from a wide variety of sources. In order to maintain reasonable fidelity between images, a palette is sought that provides a limited but universal selection of colors for common use in all images. As an example, a so-called web-safe palette has been in common use. This palette provides for 6 evenly spaced values in each of red, green, and blue. The result is a 216 color palette. Microsoft Corporation adds 16 “fixed system colors” as well as a number of black-to-white gray levels to the 216 colors to establish their “Windows 256-color default palette”. The same 216 web-safe colors are combined with a different set of system colors to establish the Apple Macintosh 256 color default palette. Graphics designers will restrict the colors in their images to the 216 color web-safe palette if they want their work to appear consistently on multiple computer platforms, and especially if some of those platforms support only 8 bits per pixel in their graphics processing.

Many master palettes are developed specifically for certain software applications. Presentation software, for instance, allows a user to define and standardize his own color palette with up to 256 colors. A GPS or portable navigation device (PND) may employ different color palettes for the display of different types of maps, depending on whether topographic data is to be shown or traffic information. A significant number of business applications, such as word processors or spreadsheets, make use of master color palettes. Any of these palettized color schemes can be reproduced with fidelity in the 12 bpp pre-set imaging mode of this invention.

The 12 bpp pre-set imaging mode supports the display of 4,096 colors. The 12 bpp pre-set mode is therefore more likely to contain the colors requested by an indexed color palette than would be the case for imaging with the 9 bpp pre-set mode. The 12 bpp pre-set imaging mode is particularly successful at matching the colors defined by the standard or master color palettes, since the colors contained in a master color palette can be mapped into (or displayed with) the 12 bpp color space without imposing any significant errors in their intended hue or saturation. In fact the 12 bpp pre-set imaging mode can exactly reproduce the 216 color web-safe palette described above, whereas the 9 bit per pixel pre-set mode cannot.

For many images, the 12 bpp pre-set imaging mode can be successfully applied for the display of images with adaptive color palettes. Banding may appear in this pre-set mode for certain natural world images, especially where the adaptive palette includes a high density of closely spaced colors in the vicinity of a particular bias color. The image artifacts introduced when one applies the 12 bpp mode to an image with an 8-bit adaptive palette will still be fewer than those imposed by applying the 12 bpp mode to a 24 bpp truecolor image.

Color Spaces that are Defined and Synthesized with the Use of Additional Primary Colors or Unusual Combinations of Primary Colors

Based on the number of supported colors, a 12 bit per pixel (truecolor) pre-set imaging mode will reproduce more images with more fidelity than a 9 bit per pixel pre-set imaging mode. However for image quality, the 12 bpp mode is still a compromise compared to a 24 bpp image, since it can still introduce artifacts such as banding when reproducing natural-world photographs or video. Faced with a tradeoff between image quality and reduced bit depth or power consumption, the designer therefore seeks the means by which pre-set imaging modes with a reduced number of bits per pixel can more faithfully reproduce a wider and wider range of images.

In one solution to the tradeoff between image quality and reduced bit depth, color spaces are proposed which include the display of additional primary colors. Instead of displaying the same three colors of red, green, and blue with additional bit depths, the quality of the image can be improved by generating luminosity from additional primary colors. The additional colors can be generated from specially colored lamps or LEDs. The additional colors can alternately be generated from special color filter materials. Or in a preferred embodiment, the colors can be generated by mixing the radiation from the red, green, and blue lamps or LEDs in specially colored sub-frame image. Examples of additional colors that can be provided are white, cyan, magenta, or yellow.

In one embodiment the controller can receive image data coded specifically for a color space which makes use of additional colors. The coded word can specify luminance values with an additional coordinate axis for each of the additional primaries. (As in traditional RGB color spaces, chromaticity and luminance units are defined so that human perception is anticipated as a linear sum of the luminance values specified along various color coordinates.) FIG. 15 provides a schematic illustration of the chromatic locations of some exemplary additional primary colors. The triangle 1700 is meant to represent the range of CIE x-y chromaticity values that are accessible using lamps with the primary colors red 1702, green 1704, blue 1706. The chromaticity values for additional colors are identified by the approximate x-y location or hue of their primaries, such as cyan 1708, magenta 1710, yellow 1712, and white 1714.

In another solution to the tradeoff between image quality and reduced bit depth, color spaces are proposed that include the display of unusual combinations of primary colors. In some cases the best imaging results that employ a small number of bits per pixel can be obtained from a combinations of only two primary colors, for instance white and blue or red and green. For other applications, the most economical color space for reproducing an image might be formed from a combination of a desaturated or light blue primary color along with a yellowish green and a deep red.

### Embodiment 7: Color Spaces Formed from the Primaries Red, Green, Blue, and White

In another pre-set imaging mode illustrative of a 7th embodiment of the invention, a color space is defined by luminance values along 4 different color coordinates: red, green, blue, and white. The 7^{th} embodiment employs an RGBW color space as opposed to a truecolor space; 12 unique bitplanes are displayed in a time division grayscale device within each image frame. Three sub-frame images are illuminated for each of the colors red, green, and blue in the image frame, and an additional 3 sub-frame images are illuminated with the primary color white. The chromaticities employed for the red, green, and blue primaries can be those defined by the sRGB standard color space, or alternately a more saturated color gamut can be established by using the primary chromaticities available directly from the LED lamps. The coded word that specifies colors for the 12-bit RGBW pre-set mode can be expressed as:

(R₀, R₁, R₂, G₀, G₁, G₂, B₀, B₁ B₂, W₀, W₁, W₂,)

Binary Word for Specifying Color Points in a 12 Bit RGBW Color Space

In time division grayscale embodiments, at least one sub-frame image corresponding to each of the bits in the above coded word will be illuminated within the period of each image frame. The relative chromaticities for each of the above primaries are identified by the letters R, G, B, and Win FIG. 15. The subscripts for each of the bit levels is meant to indicate their place value or significance in binary coding.

The 12 bit RGBW color space has the same number of color points, 4096, as in the 12 bit truecolor space, but in this case a much larger number of color points (nearly half) are located in the vicinity of the white point. Similarly, in the natural world the majority of or the predominant colors are desaturated. Therefore, even though the 12 bit RGBW space includes the loading of the same number of bitplanes as its truecolor counterpart, the RGBW space can faithfully reproduce a larger number of natural world images than its truecolor counterpart.

In an alternate application, the RGBW pre-set mode is useful for the display of maps. It allows for a large number of saturated colors and still provides a high density of color points near the white point, which the map can use for showing gray level variations in background topography or area photography.

There are 3 methods by which a color space with additional primaries, where the RGBW space is just one example, can be implemented for the reproduction of images. In the first method, a mapping or interpolation routine is implemented within the controller, such as controller 1000. The mapping routine can receive image data in either 16 bpp or 24 bpp truecolor format and identify a color point in a 12 bpp RGBW space that most closely represents the hue, saturation, and luminance value for each pixel in the data set. The mapping routine reassigns color values for the pixel according to an RGBW coding scheme like the one illustrated above.

In the 2d method for implementing an RGBW color space, the 4096 RGBW color points are employed as a superset of colors from which a palette of 256 indexed color points can be chosen. An indexed color palette derived from the RGBW space will most likely include a greater number of natural colors than what is found in the 216 color web-safe color palette. The RGBW pre-set imaging mode, therefore, will more accurately reproduce images that have been compressed using an adaptive color indexing scheme.

In the 3d method for implementing an RGBW color space, a transformation algorithm or conversion matrix can be implemented that converts 16 bpp or 24 bpp truecolor coordinates directly into corresponding RGBW color points. In one possible algorithm (and there exist a large number of possible conversion algorithms) the luminance or the Y-component of the tri-stimulus value can be calculated for each pixel, and then a percentage between 40% and 60% of the Y-component (or a sliding percentage of Y based on saturation) can be assigned as the white value in the RGBW coded word. The truecolor coordinates of the pixel that remain after a certain Y-value has been subtracted are then be used directly for the RGB values in the RGBW coded word.

In alternate embodiments of the RGBW pre-set imaging mode, different bit depth can be employed for the coded word. For instance only 2 bit levels for white can be employed along with 3 each of red, green, and blue. Or only 2 bit levels can be employed for red, green, and blue along with 3 bit levels for white. This 9 bit RGBW pre-set mode compares favorably against the 9 bit truecolor imaging mode described above. Generally any number of bit levels between 1 and 8 can be chosen for any of the colors in an RGBW coding scheme.

An RGBW pre-set imaging mode also has advantages for the reproduction of graphical or text images. Line drawings or large font text present an artifact called aliasing when viewed on pixellated displays with reduced or limited bit depth. A diagonal or curved line that is intended to be straight can look jagged on a pixellated display. Anti-aliasing routines are available which assign colors or luminosity with intermediate gray levels to any pixel that is situated in the boundary between a line or an object and its contrasting background—thereby creating the appearance of a smooth line. Many anti-aliasing routines do not operate well within an indexed color palette, since an insufficient number of gray levels are available for each color. The 12 bit RGBW imaging mode described above includes 64 gray levels between white and black, and a large number of intermediate colors in the desaturated spaces between say white and blue. Even the 9 bit RGBW described above has 32 gray levels between white and black. The RGBW pre-set imaging modes, therefore, can be programmed to operate successfully for the anit-aliasing of text and line graphics.

A 6 bit RGBW pre-set mode is another useful embodiment of the invention. A 6 bit RGBW pre-set mode can include a single bit level for each of red, green, and blue and 3 bit levels for the white primary. This 6 bit RGBW mode would include 64 total colors, of which 16 would be gray levels between white and black. This 6 bit RGBW mode therefore still provides anti-aliasing capabilities for the imaging of text and graphics. Further, the 6 bit RGBW image mode can be incorporated with business or engineering applications such as databases, control panels, word processing, and/or spreadsheets, where it provides for strong black and white contrast while still providing a substantial number of colors for use in title bars or icons.

### Embodiment 8: Color Spaces Formed from with Additional Cyan, Magenta, and/or Yellow Primaries

In another pre-set imaging mode illustrative of an 8th embodiment of the invention, a color space is defined by luminance values along 6 different color coordinates: red, green, blue, cyan, magenta, and yellow. The 8^{th} embodiment employs an RGBCMY color space as opposed to a truecolor space; 12 unique bitplanes are displayed in a time division grayscale device within each image frame. Three sub-frame images are illuminated for each of the colors red, green, and blue in the image frame, and one additional sub-frame image is illuminated for each of the alternate primaries cyan, magenta, and yellow. The chromaticities employed for the red, green, and blue primaries can be those defined by the sRGB standard color space, or alternately a more saturated color gamut can be established by using the primary chromaticities available directly from the LED lamps. The coded word that specifies colors for the 12-bit RGBCMY pre-set mode can be expressed as:

(R₀, R₁, R₂, G₀, G₁, G₂, B₀, B₁ B₂, C₀, M₀, Y₀)

Binary Word for Specking Color Points in a 12 Bit RGBCMY Color Space

In time division grayscale embodiments, at least one sub-frame image corresponding to each of the bits in the above coded word will be illuminated within the period of each image frame.

FIG. 15 provides just one embodiment of a relation between the chromaticities of the RGB and the CMY primary colors for display of sub-frame images in this pre-set imaging mode. The primaries cyan 1708, magenta 1710, and yellow 1712 are situated on the edge of the color triangle 1700. This embodiment results when the color yellow, for example, is produced by an equal mixture of luminance from the green 1704 and the red 1706 primaries. In alternate embodiments the primary colors C, M, and Y can be produced with saturations either greater or less than those indicated along the edge of the triangle 1700 in FIG. 15. More saturated colors C, M, and Y can be produced if the RGB points 1702, 1704, and 1706 are restricted to the standard sRGB chromaticities while the C, M, and Y points are produced by mixing of radiation from the more saturated LED colors. Alternately, a desaturated set of C, M, and Y primaries can be produced (with color points lying inside the triangle 1700) if each of the primaries C, M, and Y includes substantial contributions from all three of the colors R, G, and B.

The 12 bit RGBCMY color space illustrated by the primaries in FIG. 15 provides a more desaturated color space when compared to the 12 bit truecolor space. A greater number of colors is provided in a circular ring or hues about the white point at saturation levels intermediate between the white point and the RGB primaries. The 12 bit RGBCMY color space, therefore, may be advantageous for use with reduced bit depth animated images since it provides for a greater variety in hues in its available colors, while sacrificing only some bit levels at the most saturated points of the color space.

In alternate embodiments the RGBCMY pre-set modes can employ a variety of different bit depths in the coded word. For instance a 9 bit RBBCMY pre-set mode can be established that utilizes only 2 bit levels for each of red, green, and blue as well as 1 bit level each for cyan, magenta, and yellow. Generally any number of bit levels between 1 and 8 can be chosen for any of the colors in an RGBCMY coding scheme.

Pre-set imaging modes can also employ just a subset of the colors shown in the RGBCMY color space. Certain images may require a large number of hues centered near green, for instance, in which case the color space could include 2 bit levels for each of red and blue, 3 bit levels for green, one bit level for cyan and yellow, while the magenta color field is omitted altogether. The designer will recognize that a large number of alternate color spaces can be created by variations on this method, and in which the density of color points can be increased or decreased in the vicinity of any particular color of his choosing.

Just as with the RGBW color space, 3 methods are available for converting the colors of a 24 bpp image into a color points that are consistent with the RGBCMY color space. A mapping or interpolation algorithm can be employed for the conversion. Alternately, color indexing palettes can be provided that make better use of the colors supported by the RGBCMY color space. And alternately algorithms can be developed that transform colors from the 24 bpp images directly. For instance the RGB color matrix can be projected directly onto the cyan, magenta, and yellow color planes so that luminance values for these particular colors can be calculated.

The RGBCMY pre-set mode is useful for the reproduction of natural world images because it supports a large range of hues and deemphasizes those with the most extreme saturation. The RGBCMY pre-set mode is also useful for the anti-aliased reproduction of graphical and text images, since it includes 16 gray levels between black and white. For similar reasons, the RGBCMY pre-set mode provides imaging advantages for applications such as maps, document viewing, and spreadsheets.

### Embodiment 9: Fine Variations in Gray Scale by Using Only 2 Colors

In another pre-set imaging mode illustrative of a 9th embodiment of the invention, a color space is defined by luminance values along only 2 primary color coordinates. We will refer to the 9^{th} embodiment of a color space as the ST color space, where S and T are general symbols for any 2 colors chosen and/or mixed from the available gamut of the LEDs. In a specific example, we illustrate two exemplary color primaries S 1602 and T 1604 in FIG. 16, in relation to the same color triangle 1700 which employed in FIG. 15. The color primary S is just on the yellow side of white (a cool white), while the color primary T is a slightly desaturated blue. In an 8 bit variation of the ST pre-set imaging mode the coded word that specifies the colors can be written as:

(S₀, S₁, S₂, S₃, T₀, T₁ T₂, T₃,)

Binary Word for Specifying Color Points in an 8 Bit ST Color Space

This 8 bit ST pre-set mode would be displayed with 8 unique bitplanes in a time division grayscale device within each image frame. Four sub-frame images would be illuminated for each of the color primaries S and T. The chromaticities chosen for the 2 primaries S and T can be any of those accessible by the mixing of red, green, and blue LEDs, with the two color points 1602 and 1604 just providing an illustrative example.

Clearly variations of the 8 bit algorithm are possible, using any number of bit levels for each of the colors between 1 and 8.

In an alternate embodiment, additional colors can be added for the expression of a unique or unusual custom color space. For instance the triad of colors white, green and yellow would make for an interesting and unusual color space for imaging. Or the triad of colors red, white, and blue would make for a strongly contrasting color space. Or the colors cyan, magenta, yellow, and white could make for a densely populated and desaturated color space.

The 8 bit ST pre-set mode built from the colors white and blue would have strong advantages in graphical and text applications, since a large number of gray levels would be available either in white or a bluish-tinged white (more than 100). Many engineering illustrations such as isometric views from 3D modeling programs depend on fine variations in gray shading or shadowing to show details and contours within a structure. These images are most effective if restricted to a single color. The 8 bit ST algorithm considered here provides 256 shades of blue and gray for use in the viewing of engineering or design applications.

### Embodiment 10: 6 Bits per Pixel (Truecolor)

A pre-set imaging mode can also include the display of only 6 bits per pixel using truecolor coordinates, according to a 10^{th} illustrative embodiment of the invention. In this 10^{th} embodiment, 6 unique bitplanes are displayed in a time division grayscale device within each image frame. Only 2 sub-frame images would be illuminated in this embodiment for each of the colors red, green, and blue in the image frame, with their illumination values scaled according to binary coding. The color space employed for this 6 bit pre-set mode can be defined by the sRGB primary colors, or a more saturated color gamut can be established by using the primary chromaticities available directly from the LED lamps. The coded word that specifies colors for the 6-bit truecolor pre-set mode can be expressed as:

(R₀, R₁, G₀, G₁, B₀, B₁)

In time division grayscale embodiments, at least one sub-frame image corresponding to each of the 6 bits in the above coded word will be illuminated within the period of each image frame.

The 6 bit pre-set mode includes 64 total colors, and supports the 16 “system default” colors specified by Windows operating systems, including Windows CE. (These same 16 default colors were employed for the original 16 colors supported in early 4-bit CGA video adapters.) The 6 bit pre-set mode includes 3 gray levels between white and black.

The 6 bit pre-set mode can be employed as a low power imaging mode for system standby operation, including displays for recording time and incoming phone numbers or text messages. The 6 bit pre-set mode is also sufficient for the simplest of games, such as Pong, Pacman, or Sodoku.

The image quality available in the 6 bit pre-set mode can be improved by providing for the substitution of a white primary color with 1 bit governing a white sub-frame image in place of one of the blue bit levels. Alternately, a 3d bit level of green could be provided at the expense of one of the blue bit levels.

### Embodiment 11: A White-Only Display

The simplest of pre-set imaging modes provides for the display of only white as a color. A display that normally operates with red, green, and blue lamps can mix the radiation from those lamps so that only white is provided to illuminate sub-frame images.

In one alternative of this 11^{th} embodiment of the invention, the pre-set imaging mode can support the display of numerous gray scale values. Pre-set modes can be established that support 4, 8, 16, 64, or 256 gray levels by means of a 2, 3, 4, 6, or 8 bit levels bit in the word for black and white images, employing binary coding. In the example of a 4 bpp white pre-set mode, only 4 bitplanes would be illuminated within an image frame, each with the same white color, to display 16 different gray levels.

The black and white pre-set modes are valuable for the display of black, white, and gray graphical images or text. A pre-set mode that employs white only illumination will not be hampered by the artifact of color break up. As a consequence, the number of sub-frame images that need to be displayed per second is strongly reduced.

The lowest power alternative amongst the pre-set modes is achieved with a simple 1 bit per pixel black and white imaging mode. The 1 bpp pre-set mode is still sufficient for viewing most type fonts in a text application, such as a clock, status indicators, or email messages. A 1 bpp pre-set application allows for the use of a wide variety or a relaxed specification on screen refresh rate. Normally incoming video data requires the update of information according to a 24, a 30 , or a 60 Hz frame rate. In the lowest power 1 bit per pixel mode, such as a standby mode for the portable device, the screen can be refreshed at frequencies considerably less than 24 Hz, including refresh rates as low as once per second or once per 5 seconds. If only 1 bit per pixel in black and white is displayed, the display operates as a quasi-static display. With refresh rates below 5 Hz, imaging artifacts such as flicker are substantially eliminated.

1. A field sequential display comprising:
at least two lamps which output different colors,
a controller configured for:
receiving information from a host device in which the field sequential display is incorporated;
selecting, based on the received information, a display mode from a plurality of preset display modes; and
outputting signals indicating brightness levels with which to illuminate the at least two lamps based on the selected display mode.

2. The field sequential display of claim 1, comprising an array of light modulators, wherein the processor is configured to regulate drive signals applied to the array at times determined based on the selected display mode.

3. The field sequential display of claim 1, wherein the controller is configured to select the display mode by identifying a display mode that consumes less power in comparison to at least one other display mode of the plurality of preset display modes.

4. The field sequential display of claim 1, wherein each of the plurality of preset display modes has an associated plurality of imaging characteristics, and wherein each of the plurality of preset display modes includes a unique combination of imaging characteristic values.

5. The field sequential display of claim 4, wherein the plurality of imaging characteristics includes at least a color gamut.

6. The field sequential display of claim 4, wherein the plurality of imaging characteristics includes at least a number of bit levels used in the display mode to display colors.

7. The field sequential display of claim 4, wherein the plurality of imaging characteristics includes at least a level of gamma correction.

8. The field sequential display of claim 4, wherein the plurality of imaging characteristics includes at least a frame rate.

9. The field sequential display of claim 4, wherein the plurality of imaging characteristics includes at least a resolution characteristic.

10. The field sequential display of claim 4, wherein the plurality of imaging characteristics includes at least a brightness level.

11. The field sequential display of claim 1, wherein the information received from the host device based on which the controller selects the display mode comprises raw image data.

12. The field sequential display of claim 1, wherein the information received from the host device based on which the controller selects the display mode comprises an identifier of a type of image to be displayed.

13. The field sequential display of claim 1, wherein the information received from the host device based on which the controller selects the display mode comprises an identifier of the display mode.

14. The field sequential display of claim 1, wherein the information received from the host device based on which the controller selects the display mode comprises an identifier of a user mode selected by a user of the host device.

15. The field sequential display of claim 1, wherein the information received from the host device based on which the controller selects the display mode comprises an identifier of a type of content to be displayed.

16. The field sequential display of claim 1, wherein the information received from the host device based on which the controller selects the display mode comprises an identifier of a device operating mode.

17. The field sequential display of claim 1, wherein the information received from the host device based on which the controller selects the display mode comprises at least two of raw image data, an identifier of a type of image to be displayed, an identifier of a user mode selected by a user of the host device, an identifier of a type of content to be displayed, and an identifier of a device operating mode.

18. The field sequential display of claim 1, wherein the processor is configured to receive the information from the host device according to a predetermined codec.

19. The field sequential display of claim 1, wherein selecting a display mode comprises selecting a combination of the plurality of display modes.

20. The field sequential display of claim 1, comprising a memory for storing the plurality of preset image modes.

21. (canceled)

22. (canceled)
